(19) United States
(12) Patent Application Publication
(10) Pub. No.: US 2014/0044195 A1
(43) Pub. Date: Feb. 13, 2014

(54) IMAGE DECODING METHOD AND IMAGE DECODING APPARATUS

(71) Applicant: Panasonic Corporation, Osaka (JP)

(72) Inventors: Daisaku KOMIYA, Tokyo (JP); Takahiro NISHI, Nara (JP); Youji SHIBAHARA, Osaka (JP); Hisao SASAI, Osaka (JP); Toshiyasu SUGIO, Osaka (JP); Kyoko TANIKAWA, Osaka (JP); Toru MATSUNOBU, Osaka (JP); Kengo TERADA, Osaka (JP)

(73) Assignee: Panasonic Corporation, Osaka (JP)

(21) Appl. No.: 13/960,297

(22) Filed: Aug. 6, 2013

Related U.S. Application Data
(60) Provisional application No. 61/681,782, filed on Aug. 10, 2012.

(51) Int. Cl. H04N 7/26

(52) U.S. Cl. CPC H04N 19/00945
USPC 375/240.25

(57) ABSTRACT

An image decoding method includes controlling whether decoding of a first leading picture is to be performed or skipped, according to a first random access point (RAP) picture type and regardless of a first leading picture type, when decoding starts from a first RAP picture. The first leading picture follows the first RAP picture in decoding order and precedes the first RAP picture in display order. The first RAP picture type is a type of the first RAP picture, and the first leading picture type is a type of the first leading picture.

### CROSS REFERENCE TO RELATED APPLICATION

The present application claims the benefit of U.S. Provisional Patent Application No. 61/681,782 filed Aug. 10, 2012. The entire disclosure of the above-identified application, including the specification, drawings and claims is incorporated herein by reference in its entirety.

### FIELD

The present disclosure relates to an image decoding method of decoding images.

BACKGROUND

Non Patent Literature 1 discloses a technique of a method of decoding images.

### CITATION LIST

### Non Patent Literature

### [NPL 1] ISO/IEC 14496-10 “MPEG-4 Part 10 Advanced Video Coding”

### SUMMARY

### Technical Problem

However, in an image decoding method with large processing amount, processing delay may occur. Furthermore, implementation of the image decoding method with large processing amount is difficult.

In view of this, one non-limiting and exemplary embodiment provides an image decoding method which is capable of reducing the processing amount for decoding images.

### Solution to Problem

An image decoding method according to an aspect of the present disclosure includes controlling whether decoding of a first leading picture is to be performed or skipped, according to a first random access point (RAP) picture type and regardless of a first leading picture type, when decoding starts from a first RAP picture, the first leading picture following the first RAP picture in decoding order and preceding the first RAP picture in display order, the first RAP picture type being a type of the first RAP picture, the first leading picture type being a type of the first leading picture.

These general and specific aspects may be implemented using a system, an apparatus, an integrated circuit, a computer program, or a non-transitory recording medium, such as a computer-readable CD-ROM, or any combination of systems, apparatuses, methods, integrated circuits, computer programs, or recording media.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

The image decoding method according to an aspect of the present disclosure is capable of reducing the processing amount for decoding images.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram showing relationship between random access point (RAP) pictures and leading pictures.

FIG. 2 is a diagram for illustrating IDR pictures.

FIG. 3 is a diagram for illustrating BLA pictures.

FIG. 4 is a diagram for illustrating classification of the leading pictures.

FIG. 5 is a diagram showing NAL unit types relative to RAP pictures and leading pictures.

FIG. 6 is a flowchart of operations of a decoder.

FIG. 7 is a block diagram showing a configuration of an image decoding apparatus according to Embodiment 1.

FIG. 8 is a flowchart of operations of the image decoding apparatus according to Embodiment 1.

FIG. 9 shows an example of output pictures according to Embodiment 1.

FIG. 10 is a flowchart of operations of an image decoding apparatus according to Embodiment 2.

FIG. 11 is a flowchart of operations of the image decoding apparatuses according to Embodiments 1 and 2.

FIG. 12 shows an overall configuration of a content providing system for implementing content distribution services.

FIG. 13 shows an overall configuration of a digital broadcasting system.

FIG. 14 shows a block diagram illustrating an example of a configuration of a television.

FIG. 15 shows a block diagram illustrating an example of a configuration of an information reproducing/recording unit that reads and writes information from and on a recording medium that is an optical disk.

FIG. 16 shows an example of a configuration of a recording medium that is an optical disk.

FIG. 17A shows an example of a cellular phone.

FIG. 17B is a block diagram showing an example of a configuration of a cellular phone.

FIG. 18 illustrates a structure of multiplexed data.

FIG. 19 schematically shows how each stream is multiplexed in multiplexed data.

FIG. 20 shows how a video stream is stored in a stream of PES packets in more detail.

FIG. 21 shows a structure of TS packets and source packets in the multiplexed data.

FIG. 22 shows a data structure of a PMT.

FIG. 23 shows an internal structure of multiplexed data information.

FIG. 24 shows an internal structure of stream attribute information.

FIG. 25 shows steps for identifying video data.

FIG. 26 shows an example of a configuration of an integrated circuit for implementing the moving picture coding method and the moving picture decoding method according to each of Embodiments.

FIG. 27 shows a configuration for switching between driving frequencies.

FIG. 28 shows steps for identifying video data and switching between driving frequencies.

FIG. 29 shows an example of a look-up table in which video data standards are associated with driving frequencies.

FIG. 30A is a diagram showing an example of a configuration for sharing a module of a signal processing unit.

FIG. 30B is a diagram showing another example of a configuration for sharing a module of the signal processing unit.

### DESCRIPTION OF EMBODIMENTS

### (Underlying Knowledge Forming Basis of the Present Disclosure)

In relation to the image decoding method disclosed in the Background section, the inventors have found the following problem which will be specifically described below.

Playback of a recorded program from one point in the program is generally referred to as random access playback. There is a high demand for the random access playback. In a bitstream in which moving pictures are coded, random access points are set for allowing random access playback. A random access point is a point from which the bitstream is played back when the bitstream is played back from one point in the bitstream. A picture set as a random access point is referred to as a random access point (RAP) picture.

When moving pictures are coded using temporal correlation between pictures, as in MPEG, it is difficult to decode a bitstream in which moving pictures are coded, from an arbitrary position in the bitstream. However, the RAP picture is coded without depending on other pictures. Hence, it is possible to start decoding from the RAP picture.

Since the RAP picture is coded without depending on other pictures, inter-frame (inter-picture) prediction coding is not performed on the RAP picture. Hence, the RAP picture is an intra picture (I-picture) on which only intra-frame (intra-picture) prediction coding is performed.

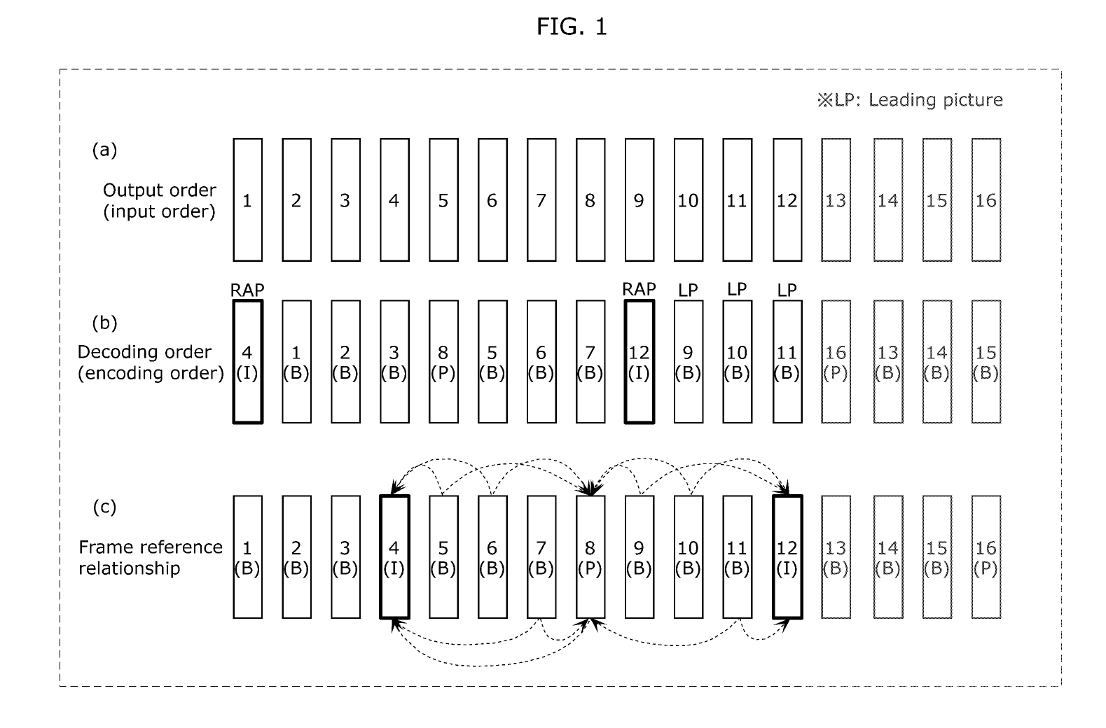

FIG. 1 is a diagram showing relationship between RAP pictures and leading pictures (LPs). In (a) of FIG. 1, the output order of decoded non-compressed pictures and the input order of input pictures to be coded are shown. Each picture is assigned with a number, and picture 1 to picture 16 are shown as examples. The picture numbers show temporal order of input or output.

In (b) of FIG. 1, the decoding order of coded pictures and the encoding order of input pictures are shown. More specifically, the pictures are coded or decoded in the order of picture 4, 1, 2, 3, 8, 5, . . . . In other words, the pictures are not coded in the input order shown in (a) of FIG. 1, but are coded in a shuffled order as shown in (b) of FIG. 1. Furthermore, the pictures are not decoded in the output (display) order shown in (a) of FIG. 1, but are decoded in the order shown in (b) of FIG. 1.

Hence, for example, the picture 4 decoded earlier is held in a buffer (decoded picture buffer (DPB buffer)) till when the picture 4 is output (displayed) after the output (display) of the pictures 1, 2, and 3.

In (c) of FIG. 1, relationship of frame reference (frame reference relationship) used in inter-frame prediction coding is shown. In (c) of FIG. 1, frame reference relationship among the picture 4 that is a RAP picture to picture 12 that is a next RAP picture, is shown as an example. The dashed arrows indicate reference between frames. A picture from which a dashed arrow starts uses a picture to which the dashed arrow is directed, as a reference picture for prediction coding. Here, the term “a first picture refers to a second picture” means that the second picture is used as a reference picture for prediction of the first picture.

For example, all of the pictures 5, 6, and 7, which are B-pictures, refer to the pictures 4 and 8. The picture 8, which is a P-picture, refers to the picture 4. All of the pictures 9, 10, and 11, which are B-pictures, refer to the pictures 8 and 12. The pictures 4 and 12, which are I-pictures, refer to no other pictures.

In coding of moving pictures, a picture (picture A) that is referred to by another picture (picture B) is coded earlier than the picture B. Furthermore, in decoding moving pictures, a picture (picture C) that is referred to by another picture (picture D) is decoded earlier than the picture D. Hence, in the case where a prediction structure (frame reference relationship) in (c) of FIG. 1 is used relative to the input order in (a) of FIG. 1, for example, the encoding order (decoding order) in (b) of FIG. 1 is used. More specifically, after the picture 4, which is a RAP picture, is coded, the picture 8 is coded by referring to the picture 4, and the pictures 5, 6, and 7 are sequentially coded by referring to the pictures 4 and 8. Subsequently, the picture 12, which is a RAP picture, is coded, and the pictures 9, 10, and 11 are sequentially coded by referring to the pictures 8 and 12.

Decoding is performed in the similar manner. More specifically, after the picture 4, which is a RAP picture, is decoded, the picture 8 is decoded by referring to the picture 4, and the pictures 5, 6, and 7 are sequentially decoded by referring to the pictures 4 and 8. Subsequently, the picture 12, which is a RAP picture, is decoded, and the pictures 9, 10, and 11 are sequentially decoded by referring to the pictures 8 and 12.

Next, a description is given of leading pictures adopted in the high efficiency video coding (hereinafter, referred to as HEVC scheme) which is a moving picture coding method that has been currently standardized. A leading picture is a picture which follows a RAP picture in decoding order and precedes the RAP picture in output order. In the following description, when one or more leading pictures exist which follow a RAP picture in decoding order and precede the RAP picture in output order, it may be referred to that the RAP picture has leading pictures.

In the examples of (a) and (b) of FIG. 1, the pictures 9, 10, and 11 follow the RAP picture 12 in decoding order. The pictures 9, 10, and 11 precede the RAP picture 12 in output order. More specifically, the pictures 9, 10, and 11 are leading pictures of the RAP picture 12.

In the HEVC scheme, three types of RAP pictures are defined, namely, an instantaneous decoding refresh (IDR) picture, a broken link access (BLA) picture, and a clean random access (CRA) picture. The type of a RAP picture is also referred to as a RAP picture type. Furthermore, the above three RAP picture types are also referred to as the IDR picture type, the BLA picture type, and the CRA picture type.

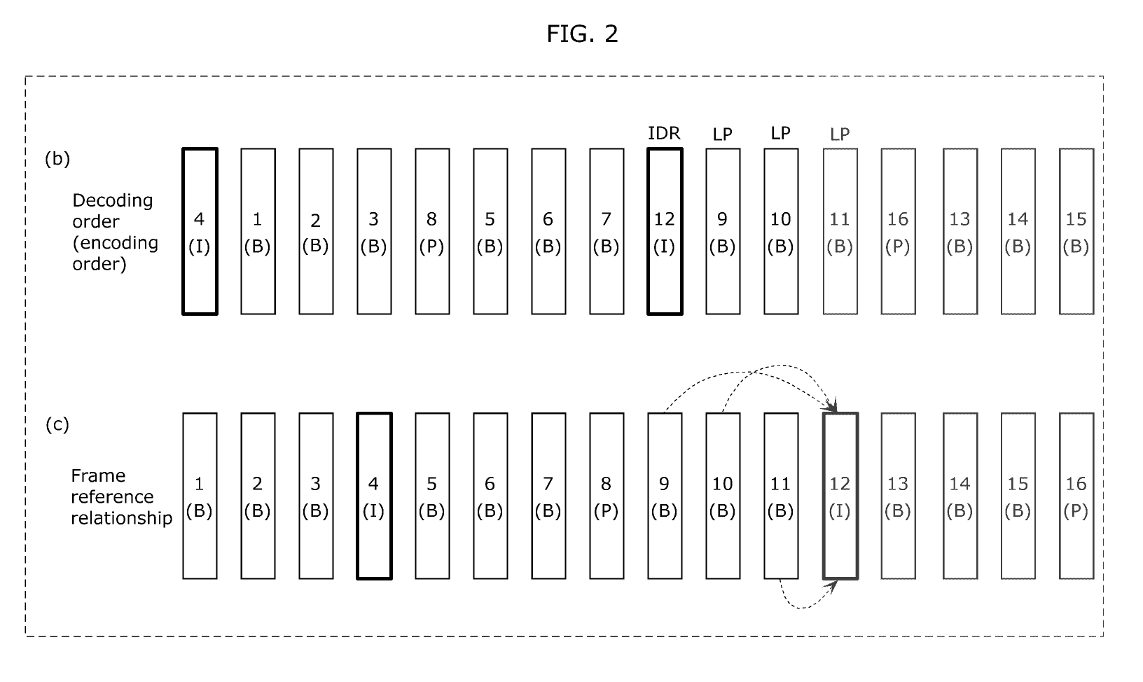

FIG. 2 is a diagram for illustrating IDR pictures. Here, the output order of decoded pictures and the input order of pictures to be coded are the same as that in (a) of FIG. 1. In (b) of FIG. 2, the decoding order of coded pictures is shown, in the similar manner to (b) of FIG. 1. However, (b) of FIG. 2 is different from (b) of FIG. 1 in that the picture 12 is an IDR picture. In (c) of FIG. 2, a frame reference relationship is shown which is used for inter-frame prediction of leading pictures of an IDR picture.

More specifically, the frame reference relationship of the leading pictures 9, 10, and 11 of the IDR picture 12 is shown. All of the leading pictures 9, 10, and 11 refer to only the IDR picture 12. With respect to the IDR pictures, it is prohibited that pictures which follow an IDR picture in decoding order refer to pictures which precede the IDR picture in decoding order.

Hence, the pictures 9, 10, and 11 are not allowed to refer to pictures (for example, the picture 8) which precede the picture 12 in decoding order. More specifically, leading pictures of an IDR picture are not allowed to refer to pictures which precede the IDR picture in decoding order. With respect to the RAP pictures other than the IDR pictures (that is, the CRA pictures and the BLA pictures), it is not prohibited that leading pictures of a RAP picture refer to pictures which precede the RAP picture in decoding order.

Next, a description is given of the BLA pictures. The BLA pictures are, for example, generated when recorded content (bitstream) is edited.

More specifically, when editing is performed such that recorded content 1 is divided into A, B, and C, and A and C are combined discarding B, the RAP picture at the beginning of C is a BLA picture. Note that content is divided at positions of the RAP pictures. Another example is that when recorded content 1 and recorded content 2 are combined, the RAP picture at the beginning of the recorded content 2 can be a BLA picture.

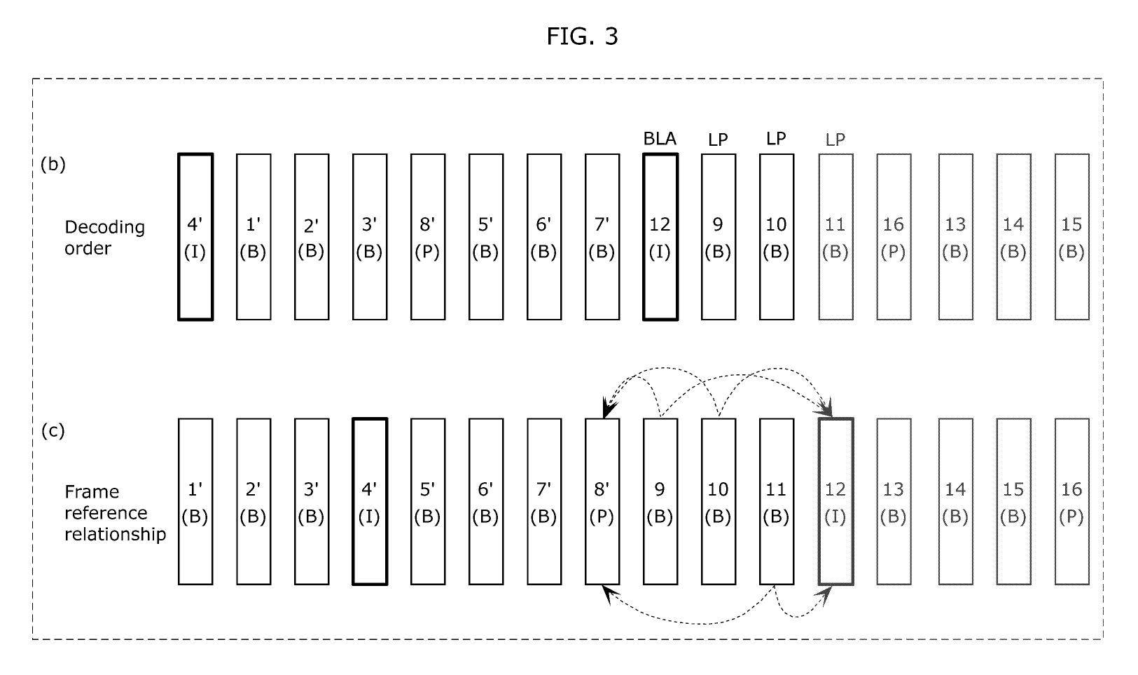

FIG. 3 is a diagram for illustrating the BLA pictures. Here, the output order of decoded pictures and the input order of pictures to be coded are also the same as that in (a) of FIG. 1.

In (b) of FIG. 3, the decoding order of coded pictures is shown, in the similar manner to (b) of FIG. 1. However, (b) of FIG. 3 is different from (b) of FIG. 1 in that the picture 12 is a BLA picture. Furthermore, (b) of FIG. 3 is different from (b) of FIG. 1 in that there is no continuity between the bitstream that is from picture 1′ to picture 8′ and the bitstream that is from picture 9 to picture 16, and the bitstreams are simply combined by editing, for example.

In (c) of FIG. 3, a frame reference relationship is shown which is used for inter-frame prediction of leading pictures of a BLA picture. As an example, the frame reference relationship of the leading pictures 9, 10, and 11 of the BLA picture 12 is shown. As shown in (c) of FIG. 3, the leading pictures 9, 10, and 11 of the picture 12 refer to the picture 8′ and the picture 12.

Here, the pictures 9, 10, and 11 are formally decodable by using the picture 8′ and the picture 12. However, the picture 8′ is not related to the pictures 9, 10, and 11 combined to the picture 8′ by editing, for example. More specifically, the picture 8′ is not a correct reference picture for the pictures 9, 10, and 11; and thus, a correct decoded image cannot be obtained. In other words, the reference structure of the leading pictures 9, 10, and 11 are broken (broken link).

The CRA pictures are RAP pictures other than the IDR pictures and the BLA pictures. Leading pictures of a CRA picture are allowed to refer to pictures which precede the CRA picture in decoding order. Hence, the coding efficiency of the CRA pictures is higher than that of the IDR pictures. In addition, the reference structure is not broken, unlike the leading pictures of a BLA picture. Hence, all of the leading pictures are decodable at the time of normal playback.

The descriptions have been given of the classification of the RAP pictures. Now, a description is given of the classification of the leading pictures.

Two types of leading pictures are defined, namely, a decodable leading picture (DLP picture) and a tagged for discard (TFD) picture. The type of a leading picture is also referred to as a leading picture type. In addition, the above two leading picture types are also referred to as a DLP picture type and a TFD picture type.

When a RAP picture is randomly accessed and decoding starts from the RAP picture (at the time of random access playback), DLP pictures are processed as decodable leading pictures. In contrast, TFD pictures are not processed as decodable leading pictures, because it is not ensured that the TFD pictures are accurately decodable at the time of random access playback.

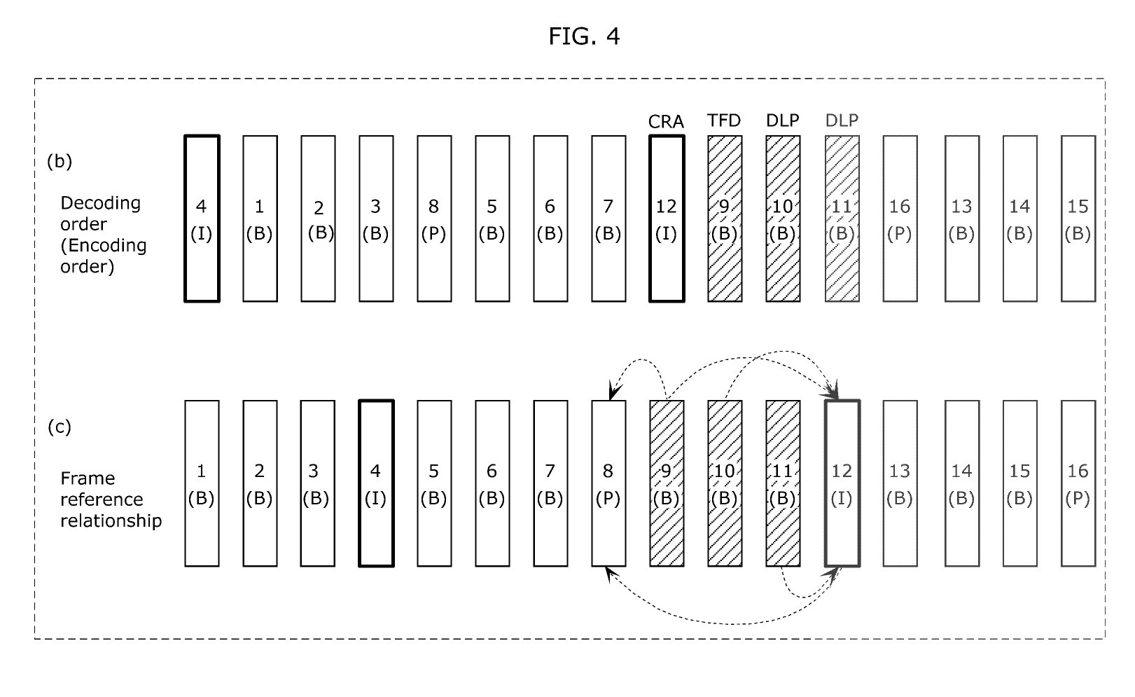

FIG. 4 is a diagram for illustrating classification of the leading pictures. Here, the output order of decoded pictures and the input order of pictures to be coded are also the same as that in (a) of FIG. 1. In (b) of FIG. 4, the decoding order of coded pictures is shown, in the similar manner to (b) of FIG. 1. However, (b) of FIG. 4 is different from (b) of FIG. 1 in that the picture 12 is a CRA picture, and that the leading pictures 9, 10, and 11 are classified into a TFD picture and DLP pictures.

In (c) of FIG. 4, an example is shown of pictures referred to by the leading pictures 9, 10, and 11 of the CRA picture 12. The picture 9 refers to the picture 8 and the picture 12. As a result, when decoding starts from the picture 12 (at the time of random access to the picture 12), the picture 8 is not usable as a reference picture. Hence, the picture 9 is a TFD picture which is not decodable. On the other hand, the pictures 10 and 11 refer to only the picture 12. As a result, when decoding starts from the picture 12, the picture 12 is usable as a reference picture. Hence, the pictures 10 and 11 are DLP pictures which are decodable.

As described earlier, leading pictures of an IDR picture are not allowed to refer to pictures which precede the IDR picture in decoding order. Hence, the leading pictures of an IDR picture are always DLP pictures.

Leading pictures of a CRA picture include at least one TFD picture. More specifically, the leading pictures of a CRA picture may include only TFD pictures or include a mixture of TFD and DLP pictures.

The leading pictures of a BLA picture may include only DLP pictures as in the IDR picture, or include at least one TFD picture as in the CRA picture. More specifically, the leading pictures of a BLA picture may include only DLP pictures, include only TFD pictures, or include a mixture of TFD and DLP pictures.

In other words, depending on the type of a RAP picture, the RAP picture has different types of leading pictures (DLP picture or TFD picture). Furthermore, there are cases where a RAP picture has no leading picture. When decoding a RAP picture, it is convenient for decoding to obtain information on the types of leading pictures of the RAP picture or information on whether or not the RAP picture has any leading pictures.

In view of this, information on a RAP picture or a leading picture is described in the NAL unit type of the NAL unit header of each network abstraction layer (NAL) unit.

A NAL unit is a unit for sectioning coded data, and includes a NAL unit header of 2 bytes (fixed length) and a payload. The NAL unit header includes a NAL unit type that is an identifier for the type of the NAL unit. The payload includes raw byte sequence payload (RBSP) that is coded data. In order for byte alignment of the RBSP (adjustment to a multiple of 8 bits), trailing bits of 1 to 8 bits are added to the end of the RBSP.

By referring to the NAL unit type, the type of the data included in the payload of the NAL unit is identified. Furthermore, the NAL unit can include not only moving picture data, but also coding parameters such as sequence parameter set (SPS) or picture parameter set (PPS).

When a NAL unit includes moving picture data, the NAL unit includes, in the payload, moving picture data in units of slices which are obtained by dividing a picture. The NAL unit types of the NAL units of the slices in a same picture have the same value.

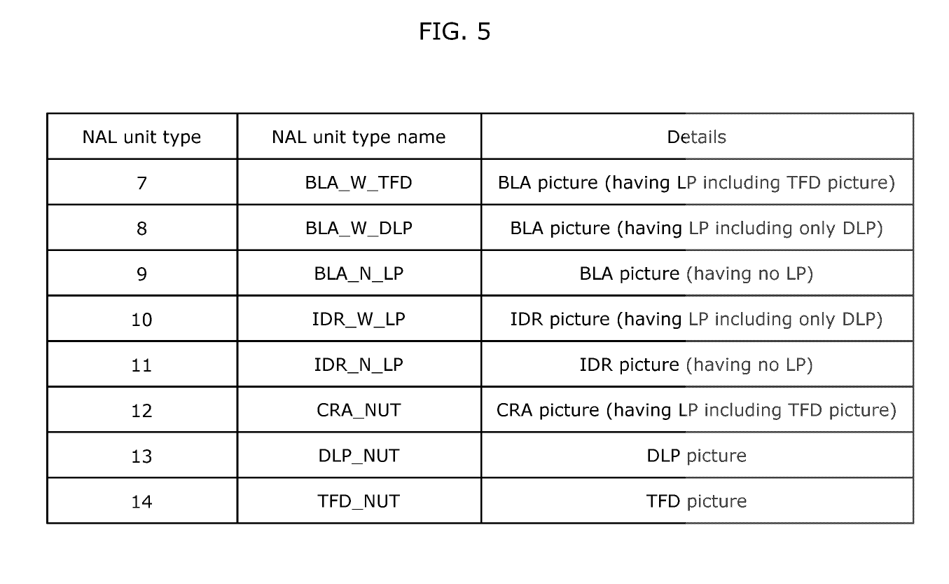

FIG. 5 is a diagram showing the NAL unit types of RAP pictures and leading pictures.

With respect to the NAL unit type of a NAL unit including a RAP picture (slices of a RAP picture), values of 7 to 9 are used for BLA pictures, values of 10 and 11 are used for IDR pictures, and a value of 12 is used for CRA pictures.

More specifically, a value of 7 is inserted to the NAL unit type of a BLA picture having leading pictures which include at least one TFD picture. A value of 8 is inserted to the NAL unit type of a BLA picture having leading pictures all of which are DLP pictures. A value of 9 is inserted to the NAL unit type of a BLA picture having no leading picture.

A value of 10 is inserted to the NAL unit type of an IDR picture having leading pictures all of which are DLP pictures. A value of 11 is inserted to the NAL unit type of an IDR picture having no leading picture.

As described above, the RAP pictures are classified into three types. However, there are six RAP types (NAL unit types) according to the types of the leading pictures (DLP picture or TFD picture) of a RAP picture and whether or not the RAP picture has leading pictures. These may also be referred to as a first IDR picture type, a second IDR picture type, a first BLA picture type, a second BLA picture type, a third BLA picture type, and a first CRA picture type.

Furthermore, as described above, two types of leading pictures are defined, which are the DLP picture and the TFD picture. A value of 13, indicating a DLP picture, is inserted to the NAL unit type of a NAL unit including a DLP picture (slices of a DLP picture). A value of 14, indicating a TFD picture, is inserted to the NAL unit type of a NAL unit including a TFD picture (slices of a TFD picture).

In the case where random access is performed on a RAP picture in a bitstream in which moving pictures are coded using the HEVC scheme, and playback starts from the RAP picture, different decoding processing is performed according to the RAP type and the leading picture type. This complicates the configuration of the decoder or decoding processing. Hence, it is beneficial to reduce the processing amount for decoding required when playback starts from the RAP picture.

An image decoding method according to an aspect of the present disclosure, includes controlling whether decoding of a first leading picture is to be performed or skipped, according to a first random access point (RAP) picture type and regardless of a first leading picture type, when decoding starts from a first RAP picture, the first leading picture following the first RAP picture in decoding order and preceding the first RAP picture in display order, the first RAP picture type being a type of the first RAP picture, the first leading picture type being a type of the first leading picture.

With this, the processing amount for decoding at the time of random access playback is reduced. In other words, it is possible to reduce the processing amount for decoding images.

For example, it may be that the first RAP picture type is one of a plurality of RAP picture types, the RAP picture types include: (i) a clean random access (CRA) picture type which is a type corresponding to a RAP picture which allows a picture following the

RAP picture in decoding order to refer to a picture preceding the RAP picture in decoding order; (ii) a broken link access (BLA) picture type which is a type corresponding to a RAP picture which has a possibility that reference from a picture following the RAP picture in decoding order to a picture preceding the RAP picture in decoding order is broken; and (iii) an instantaneous decoding refresh (IDR) picture type which is a type corresponding to a RAP picture which prohibits a picture following the RAP picture in decoding order from referring to a picture preceding the RAP picture in decoding order, the first leading picture type is one of a plurality of leading picture types, the leading picture types include: (i) a decodable leading picture (DLP) type which is a type corresponding to a leading picture that is decodable in decoding starting from a RAP picture; and (ii) a tagged for discard (TFD) picture type which is a type corresponding to a leading picture that is not ensured to be decodable in decoding starting from a RAP picture, and in the controlling, when decoding starts from the first RAP picture, whether decoding of the first leading picture is to be performed or skipped is controlled according to which one of the RAP picture types is the first RAP picture type and regardless of which one of the leading picture types is the first leading picture type.

With this, according to whether the RAP picture is a CRA picture, a BLA picture, an IDR picture, or others, decoding of the leading picture is controlled regardless of the leading picture being a DLP picture or a TFD picture.

Furthermore, for example, it may be that in the controlling, when (i) decoding starts from the first RAP picture and (ii) the first RAP picture type is the CRA picture type or the BLA picture type, decoding of the first leading picture is skipped regardless of whether the first leading picture type is the DLP picture type or the TFD picture type.

With this, when the RAP picture is a CRA picture or a BLA picture, decoding of the leading picture is appropriately skipped.

Furthermore, for example, it may be that in the controlling, when (i) decoding starts from the first RAP picture and (ii) the first RAP picture type is the IDR picture type, decoding of the first leading picture is performed regardless of whether the first leading picture type is the DLP picture type or the TFD picture type.

With this, when the RAP picture is an IDR picture, the leading picture is appropriately decoded.

Furthermore, for example, it may be that the CRA picture type includes a first CRA picture type, the first CRA picture type is a type corresponding to a RAP picture of the CRA picture type having a leading picture of the TFD picture type, the BLA picture type includes a first BLA picture type, a second BLA picture type, and a third BLA picture type, the first BLA picture type is a type corresponding to a RAP picture of the BLA picture type having a leading picture of the TFD picture type, the second BLA picture type is a type corresponding to a RAP picture of the BLA picture type having no leading picture of the TFD picture type and having a leading picture of the DLP picture type, the third BLA picture type is a type corresponding to a RAP picture of the BLA picture type having no leading picture, the IDR picture type includes a first IDR picture type and a second IDR picture type, the first IDR picture type is a type corresponding to a RAP picture of the IDR picture type having no leading picture of the TFD picture type and having a leading picture of the DLP picture type, the second IDR picture type is a type corresponding to a RAP picture of the IDR picture type having no leading picture, the first RAP picture type is one of the RAP picture types including the first CRA picture type, the first BLA picture type, the second BLA picture type, the third BLA picture type, the first IDR picture type, and the second IDR picture type, and in the controlling, when decoding starts from the first RAP picture, whether decoding of the first leading picture is to be performed or skipped is controlled according to which one of the RAP picture types is the first RAP picture type and regardless of which one of the leading picture types is the first leading picture type.

With this, decoding or skipping is appropriately controlled according to, for example, the attribute indicating whether or not the RAP picture has leading pictures.

Furthermore, for example, it may be that in the controlling, when (i) decoding starts from the first RAP picture and (ii) the first RAP picture type is one of the first CRA picture type, the first BLA picture type or the second BLA picture type, decoding of the first leading picture is skipped regardless of whether the first leading picture type is the DLP picture type or the TFD picture type.

With this, skipping is appropriately controlled according to, for example, the attribute indicating whether or not a RAP picture has leading pictures.

Furthermore, for example, it may be that in the controlling, when (i) decoding starts from the first RAP picture and (ii) the first RAP picture type is the first IDR picture type, decoding of the first leading picture is performed regardless of whether the first leading picture type is the DLP picture type or the TFD picture type. With this, decoding is appropriately controlled according to, for example, the attribute indicating whether or not the RAP picture has leading pictures.

Furthermore, for example, it may be that in the controlling, when (i) decoding starts from the first RAP picture and (ii) the first RAP picture type is a predetermined first type, decoding of the first leading picture of the DLP picture type is skipped.

With this, the processing amount for determination and for decoding are reduced. In addition, the RAP picture and the pictures which follow the RAP picture in display order can be appropriately displayed.

Furthermore, for example, it may be that in the controlling, when (i) decoding starts from the first RAP picture and (ii) the first RAP picture type is a predetermined second type, decoding of the first leading picture of the TFD picture type is performed.

With this, the processing amount for determination is reduced. Furthermore, there are cases where leading pictures are assumed to be decodable, according to the type of the RAP picture, leading to a reduction in the processing amount for error handling.

Furthermore, for example, it may be that in the controlling, when (i) decoding starts from the first RAP picture and (ii) the first

RAP picture type is a predetermined first type, a skip-flag is set, the skip-flag indicating that decoding of a leading picture is to be skipped, and in a case where the skip-flag is set, decoding of the first leading picture is skipped.

With this, decoding of the leading pictures which follow the RAP picture in decoding order is appropriately skipped.

Furthermore, for example, it may be that in the controlling, when (i) decoding starts from the first RAP picture and (ii) the first RAP picture type is a predetermined second type, a decoding flag is set, the decoding flag indicating that decoding of a leading picture is to be performed, and in a case where the decoding flag is set, the first leading picture is decoded.

With this, the leading pictures which follow the RAP picture in decoding order are appropriately decoded.

Furthermore, for example, it may be that in the controlling, the first RAP picture type is identified using a network abstraction layer (NAL) unit type of a NAL unit corresponding to the first RAP picture, and whether decoding of the first leading picture is to be performed or skipped is controlled according to the identified first RAP picture type.

With this, the type of the RAP picture is appropriately determined. In addition, since the NAL unit type can be obtained at a relatively early stage, decoding and skipping can be controlled at an early stage.

Furthermore, for example, it may be that in the controlling, when (i) decoding starts from the first RAP picture and (ii) the first RAP picture type is a predetermined type, decoding of the first leading picture is to be performed or skipped is controlled regardless of the first leading picture type, and when (i) decoding starts from the first RAP picture and (ii) the first RAP picture type is not the predetermined type, whether decoding of the first leading picture is to be performed or skipped is controlled according to the first leading picture type.

With this, when the type of the RAP picture is not a predetermined type, decoding or skipping is appropriately controlled according to the leading picture type.

For example, skipping decoding of a predetermined DLP picture allows a reduction in the processing amount for decoding. Furthermore, for example, decoding of a predetermined TFD picture allows a reduction in processing amount for error handling.

These general and specific aspects may be implemented using a system, an apparatus, an integrated circuit, a computer program, or a non-transitory recording medium such as a computer-readable recording medium, or any combination of systems, apparatuses, methods, integrated circuits, computer programs, or recording media.

Hereinafter, certain exemplary embodiments are described with reference to the accompanying Drawings. Each of the exemplary embodiments described below shows a general or specific example. The numerical values, shapes, materials, constituent elements, the arrangement and connection of the constituent elements, steps, the processing order of the steps etc. shown in the following exemplary embodiments are mere examples, and therefore do not limit the scope of the appended Claims and their equivalents. Among the constituent elements in the following exemplary embodiments, constituent elements not recited in any one of the independent claims are described as arbitrary constituent elements.

Furthermore, in the following description, the term “coding” may also mean encoding.

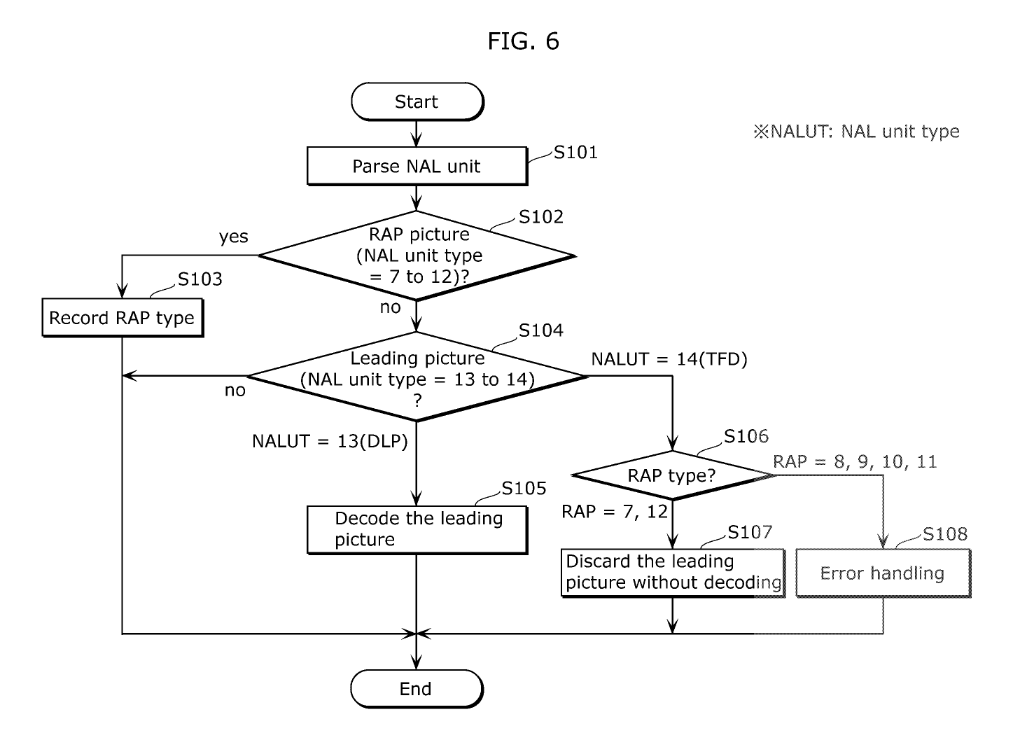

At first, referring to the flowchart in FIG. 6, a description is given of the operations, assumed by the inventors, of an ordinary decoder which decodes a bitstream in which moving pictures are coded according to the HEVC scheme.

The decoder parses a NAL unit to obtain the NAL unit type (Step S101).

When the NAL unit type is one of 7 to 12 (Yes in Step S102), the decoder recognizes that the picture in the NAL unit is a RAP picture. The decoder records the NAL unit type of the RAP picture (RAP type) in an internal memory of the decoder (Step S103), and decodes the RAP picture.

When the RAP picture has one or more leading pictures, that is, when the NAL unit type is one of 7, 8, 10, and 12, the decoder attempts to decode the leading pictures which follow the RAP picture in decoding order.

The decoder checks the NAL unit types obtained for the pictures which follow the RAP picture (Step S104). When the NAL unit type is 13 or 14 (Yes in Step S104), the decoder recognizes that the picture is a leading picture.

When the NAL unit type indicates a DLP picture (NAL unit type=13 in Step S104), the decoder decodes the leading picture (Step S105). When the NAL unit type indicates a TED picture (NAL unit type=14 in Step S104), the decoder checks the NAL unit type of the RAP picture (RAP type) (Step S106).

When the RAP type indicates a BLA picture having leading pictures including at least one TFD picture (RAP type=7 in Step S106), or when the RAP type indicates a CRA picture (RAP type=12 in Step S106), the decoder discards the leading picture without decoding the leading picture (Step S107).

On the other hand, when the RAP type is other than the above (RAP type=8, 9, 10, or 11 in Step S106), the decoder performs predetermined error handling because it is an error that the leading picture is a TFD picture or that the RAP picture includes leading pictures (Step S108).

In the following embodiments, a description is given of improvements on the ordinary decoding operations assumed by the inventors. More specifically, an image decoding apparatus and an image decoding method are proposed which reduce processing amount for decoding, in random access to a bitstream in which moving pictures are coded according to the HEVC scheme.

### EMBODIMENT 1

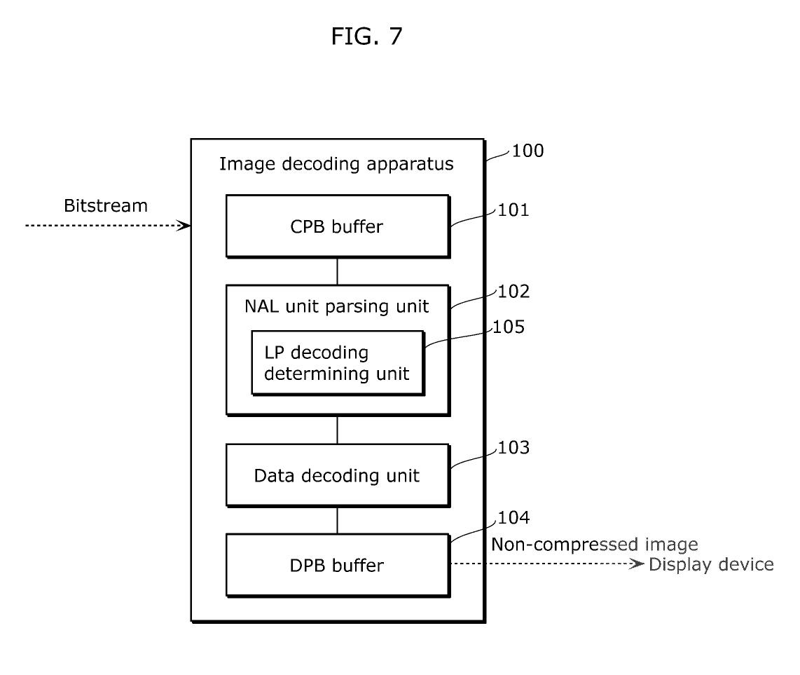

FIG. 7 is a block diagram showing a configuration of an image decoding apparatus according to Embodiment 1. As shown in FIG. 7, an image decoding apparatus 100 includes: a coded picture buffer (CPB buffer) 101, a NAL unit parsing unit 102, a data decoding unit 103, and a decoded picture buffer (DPB buffer) 104. The NAL unit parsing unit 102 includes a leading picture decoding determining unit (LP decoding determining unit) 105.

The CPB buffer 101 is a buffer for holding bitstreams input to the image decoding apparatus 100. The CPB buffer 101 outputs, on a per-picture (access unit) basis, a bitstream to the NAL unit parsing unit 102 at predetermined timing.

The NAL unit parsing unit 102 parses NAL units. The NAL unit parsing unit 102 parses each NAL unit header, and obtains information such as the NAL unit type. Subsequently, the NAL unit parsing unit 102 transmits payload information to the data decoding unit 103, for example. The leading picture decoding determining unit 105 determines whether or not a leading picture is to be decoded.

The data decoding unit 103 decodes the payload data (coded moving picture data) transmitted from the NAL unit parsing unit 102.

The DPB buffer 104 holds the pictures (non-compressed moving picture data) decoded by the data decoding unit 103. The decoded pictures are input to the DPB buffer 104 in decoding order shown in (b) of FIG. 1, for example, and output to a display device or the like in output order shown in (a) of FIG. 1.

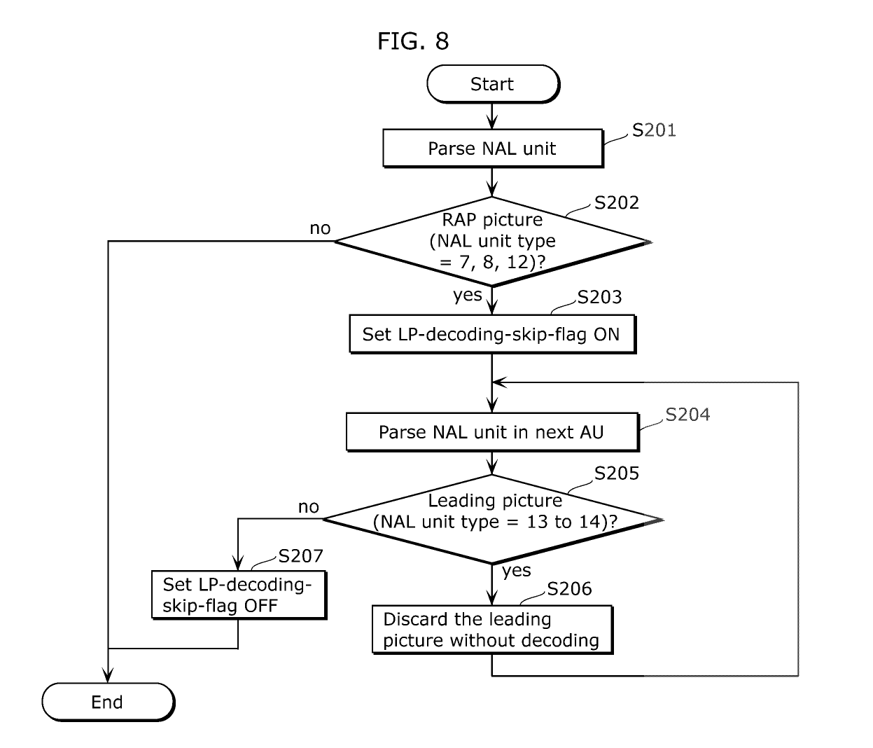

Next, referring to the flowchart in FIG. 8, a description is given of the operations of the image decoding apparatus 100. Upon receipt of NAL units of pictures (access units) from the CPB buffer 101, the NAL unit parsing unit 102 sequentially parses the NAL units in the access units (Step S201). The NAL unit parsing unit 102 then obtains the NAL unit type of each NAL unit. The NAL unit types of the NAL units of slices in a same picture have the same value.

Next, the leading picture decoding determining unit 105 checks the obtained NAL unit type (Step S202).

When the NAL unit type indicates a BLA picture or a CRA picture having leading pictures, (NAL unit type=7, 8, or 12) (Yes in Step S202), an LP-decoding-skip-flag is set ON (Step S203). More specifically, in this case, the leading picture decoding determining unit 105 determines that decoding of the leading pictures of the RAP picture (BLA picture or CRA picture) is to be skipped, and sets the LP-decoding-skip-flag (set the flag ON).

The LP-decoding-skip-flag being ON means that decoding of the leading pictures is skipped regardless of the types of the leading pictures (DLP picture or TFD picture). The RAP picture is decoded by the data decoding unit 103, and held in the DPB buffer 104.

Subsequently, the NAL unit parsing unit 102 receives the NAL unit of a next picture (access unit) from the CPB buffer 101. The NAL unit parsing unit 102 parses the NAL unit in the access unit, and obtains the NAL unit type, in the similar manner to Step S201 (Step S204).

When the NAL unit type is a leading picture (NAL unit type=13 or 14) (Yes in Step S205), the leading picture decoding determining unit 105 checks the LP-decoding-skip-flag. In step S203, the leading picture decoding determining unit 105 has determined that decoding of the leading picture is to be skipped, and has set the LP-decoding-skip-flag ON. Hence, the leading picture decoding determining unit 105 gives instructions to skip decoding of the leading picture (Step S206).

In other words, the moving picture coded data corresponding to the leading pictures is discarded without being decoded. Subsequently, the NAL unit parsing unit 102 receives the NAL unit of a next picture (access unit) from the CPB buffer 101, and the operations from Step S204 to Step S206 are repeated. As a result, the leading pictures of the RAP picture (BLA picture or CRA picture) are discarded without being decoded, regardless of whether the leading pictures are DLP pictures or TFD pictures.

When a normal picture appears after the leading pictures of the RAP picture are processed (No in Step S205), the leading picture decoding determining unit 105 sets the LP-decoding-skip-flag OFF (reset) (Step S207). As a result, the normal picture is decoded by the data decoding unit 103, and held in the DPB buffer 104.

In Step S202, when the RAP picture is other than a BLA picture or a CRA picture having leading pictures (NAL unit type=9, 10, or 11), normal decoding processing is performed. In other words, for example, normal decoding operations as shown in FIG. 6 are performed.

As described above, when the RAP picture is a BLA picture or a CRA picture having leading pictures (NAL unit type=7, 8, or 12), the image decoding apparatus 100 according to Embodiment 1 discards the leading pictures of the RAP picture, regardless of whether the leading pictures are DLP pictures or TFD pictures.

As a result, the image decoding apparatus 100 is capable of avoiding complicated processing caused due to processing performed according to the types of the leading pictures (DLP picture or TFD picture). In addition, the image decoding apparatus 100 is capable of reducing processing amount for decoding the DLP pictures.

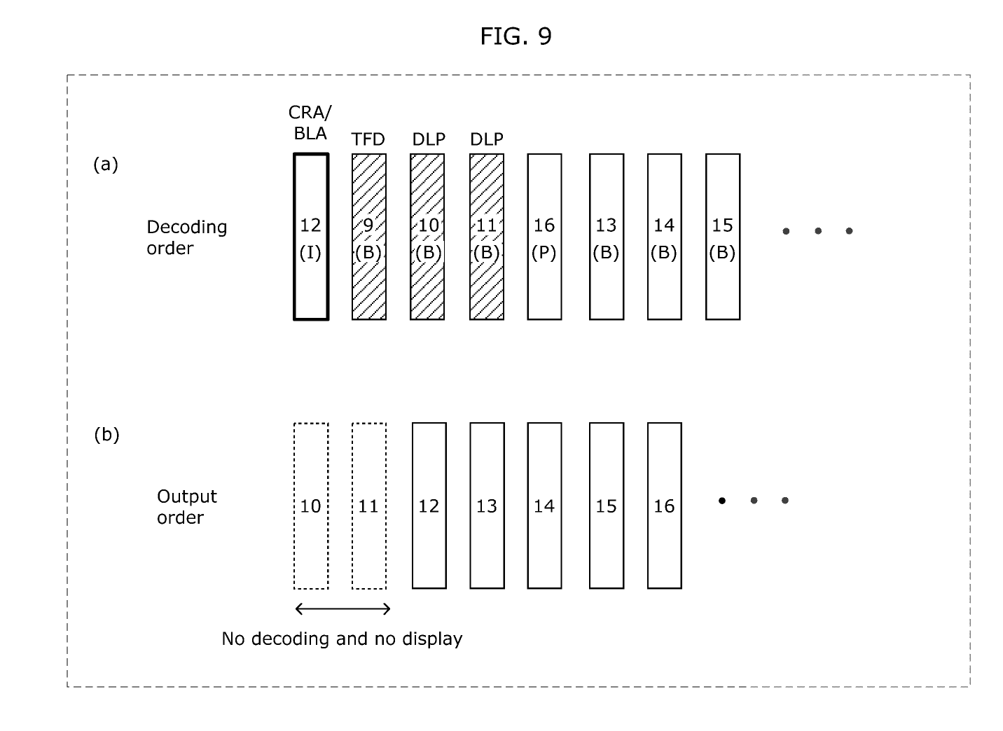

FIG. 9 shows an example of pictures output by the image decoding apparatus 100 performing random access on a RAP picture and decoding processing. In FIG. 9, (a) is basically the same as the bitstream (decoding order) shown in (b) of FIG. 4. More specifically, picture 12 is a RAP picture, and pictures 9 to 11 are leading pictures. The picture 9 is a TFD picture, and the pictures 10 and 11 are DLP pictures.

Although the picture 12 is a CRA picture in (b) of FIG. 4, the picture 12 is a CRA picture or a BLA picture in (a) of FIG. 9. In (a) of FIG. 9, the picture 12 that is a RAP picture has leading pictures including at least one TFD picture. Hence, the NAL unit type of the slice data belonging to the picture 12 is 7 or 12.

As described with reference to FIG. 8, when the RAP picture is a BLA picture or a CRA picture having leading pictures (NAL unit type=7, 8, or 12), the image decoding apparatus 100 does not decode the leading pictures of the RAP picture, regardless of whether the leading pictures are DLP pictures or TFD pictures.

Hence, as shown in (b) of FIG. 9, the pictures 9, 10, and 11 which are the leading pictures of the picture 12 are discarded without being decoded, and the picture 12 and the pictures following the picture 12 in output order are output. The image decoding apparatus 100 is capable of avoiding complicated processing caused due to processing performed according to the types of the leading pictures 9, 10, and 11 (DLP picture or TFD picture). Furthermore, the image decoding apparatus 100 is capable of reducing processing amount for decoding the DLP pictures (pictures 10 and 11).

In the normal decoding operations described referring to FIG. 6, the pictures 10 and 11, which are DLP pictures, are decoded, and the picture 10 and the pictures following the picture 10 in output order are output.

The image decoding apparatus 100 is an example of an image decoding apparatus which controls decoding or skipping of leading pictures, using the type of the RAP picture. When the RAP picture is a BLA picture or a CRA picture having leading pictures (NAL unit type=7, 8, or 12), the image decoding apparatus 100 is capable of discarding the leading pictures (pictures preceding the RAP picture in output order) without decoding the leading pictures.

Furthermore, when the RAP picture has leading pictures (NAL unit type=7, 8, 10, or 12), the image decoding apparatus 100 may discard the leading pictures (pictures preceding the RAP picture in output order) without decoding the leading pictures.

### EMBODIMENT 2

Next, a description is given of Embodiment 2. A configuration of an image decoding apparatus according to Embodiment 2 is the same as that of the image decoding apparatus 100 shown in FIG. 7. However, the leading picture decoding determining unit 105 according to Embodiment 2 determines whether to decode leading pictures, in a manner different from that in Embodiment 1. In the following description, the configuration of the image decoding apparatus 100 shown in FIG. 7 is used as a configuration of the image decoding apparatus according to Embodiment 2.

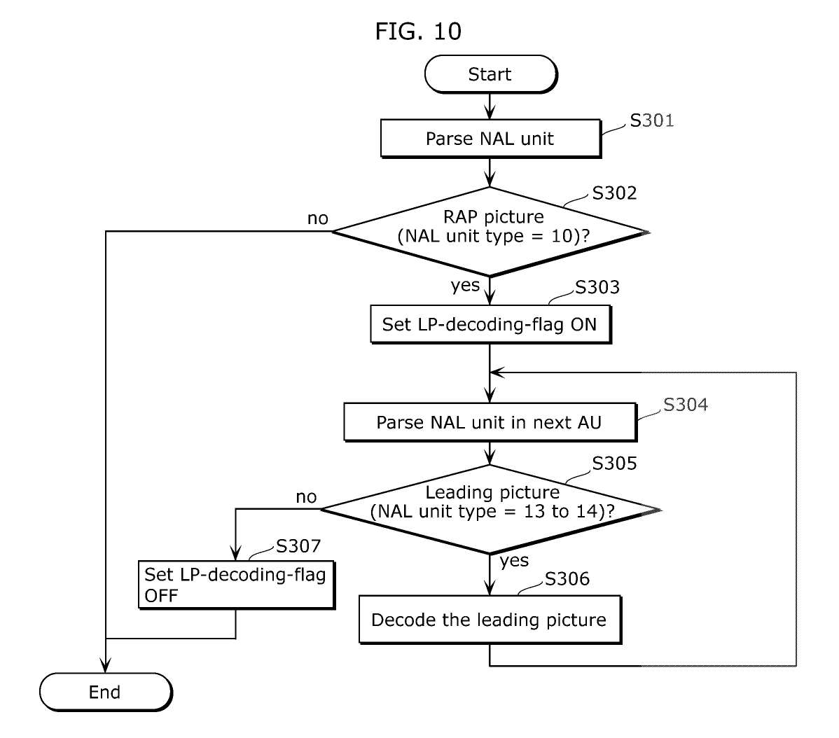

FIG. 10 is a flowchart of operations of the image decoding apparatus 100 according to Embodiment 2. First, upon receipt of NAL units of pictures (access units) from the CPB buffer 101, the NAL unit parsing unit 102 sequentially parses the NAL units included in the access units. The NAL unit parsing unit 102 then obtains the NAL unit type of each NAL unit (Step S301). The NAL unit types of the NAL units of slices in a same picture have the same value.

Next, the leading picture decoding determining unit 105 checks the obtained NAL unit type (Step S302). When the NAL unit type indicates an IDR picture having leading pictures (NAL unit type=10) (Yes in Step S302), the LP-decoding-flag is set ON (Step S303). More specifically, in this case, the leading picture decoding determining unit 105 determines that the leading pictures of the IDR picture are always to be decoded without skipping, and sets the LP-decoding-flag (set the flag ON).

The LP-decoding-flag being ON means that the leading pictures are decoded regardless of the types of the leading pictures (DLP picture or TFD picture). The IDR picture is decoded by the data decoding unit 103, and held in the DPB buffer 104.

Subsequently, upon receipt of the NAL unit of a next picture (access unit) from the CPB buffer 101, the NAL unit parsing unit 102 parses the NAL unit in the access unit, in the similar manner to Step S301 (Step S304). The NAL unit parsing unit 102 then obtains the NAL unit type.

When the NAL unit type indicates a leading picture (NAL unit type=13 or 14) (Yes in Step S305), the leading picture decoding determining unit 105 checks the LP-decoding-flag. In Step S303, the leading picture decoding determining unit 105 has determined that the leading pictures of the IDR picture are always to be decoded without skipping and set the LP-decoding-flag ON. Hence, the leading picture decoding determining unit 105 gives instructions to decode the leading picture (Step S306).

In other words, the moving picture coded data corresponding to the leading picture is always decoded without being skipped. Subsequently, the NAL unit parsing unit 102 receives the NAL unit of a next picture (access unit) from the CPB buffer 101, and the operations from Step S304 to Step S306 are repeated. As a result, the leading pictures of the IDR picture are decoded regardless of whether the leading pictures are DLP pictures or TFD pictures.

Here, under normal conditions, leading pictures of an IDR picture (NAL unit type=10) are DLP pictures. More specifically, in a bitstream that complies with the HEVC scheme, no TFD picture is included in the leading pictures of an IDR picture. If a TFD picture is included, the decoder performs error handling without decoding the TFD picture. For example, error handling processing in Step S108 in the normal decoding operations described referring to FIG. 6 are performed.

When the leading pictures of an IDR picture includes a TFD picture, the NAL unit parsing unit 102 according to Embodiment 2 interprets that it is simply due to incorrect assignment of the NAL unit type and performs error handling. More specifically, the NAL unit parsing unit 102 interprets that although the NAL unit type of the leading picture should be a DLP picture (NAL unit type=13), but has been incorrectly assigned with a TFD picture (NAL unit type=14).

If it is simply due to incorrect assignment of the NAL unit type, the leading picture is decodable even if it is a TFD picture.

When a normal picture appears after processing the leading pictures of the IDR picture (No in Step S305), the leading picture decoding determining unit 105 sets the LP-decoding-flag OFF (reset) (Step S307). As a result, the normal picture is decoded by the data decoding unit 103, and held in the DPB buffer 104.

In Step S302, when the RAP picture is other than an IDR picture having leading pictures (NAL unit type=7, 8, 9, 11, or 12), normal decoding processing is performed. In other words, for example, in this case, normal decoding operations as shown in FIG. 6 are performed.

In Embodiment 2, when a RAP picture is an IDR picture having leading pictures (NAL unit type=10), the leading pictures of the IDR picture are always decoded regardless of whether the leading pictures are DLP pictures or TFD pictures. As a result, in Embodiment 2, it is possible to avoid complicated processing caused due to processing performed according to the leading picture type (DLP picture or TFD picture), and to reduce the processing amount for error handling.

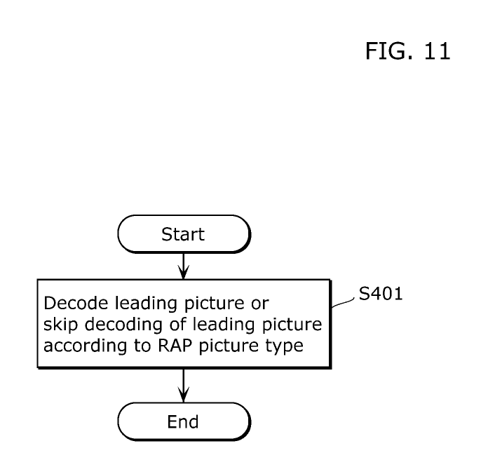

FIG. 11 is a diagram showing operations of the image decoding apparatus according to each embodiment above, for confirmation. When decoding starts from a RAP picture, the image decoding apparatus controls whether decoding of leading pictures is to be performed or skipped, according to the type of the RAP picture and regardless of the types of the leading pictures (S401). With this, the image decoding apparatus according to each embodiment above is capable of reducing processing amount for decoding images.

Each of the constituent elements in each of the above-described embodiments may be configured in the form of an exclusive hardware product, or may be implemented by executing a software program suitable for the constituent element. The constituent elements may be implemented by a program execution unit such as a CPU or a processor which reads and executes a software program recorded on a recording medium such as a hard disk or a semiconductor memory.

In other words, the image decoding apparatus includes processing circuitry and storage electrically connected to the processing circuitry (storage accessible from the processing circuitry). The processing circuitry includes at least one of a dedicated hardware and a program executing unit. When the processing circuitry includes the program executing unit, the storage stores a software program executed by the program executing unit.

Here, a software for implementing the image decoding apparatus according to each embodiment above or the like is a program as described below.

More specifically, the program causing a computer to execute an image decoding method including controlling whether decoding of a first leading picture is to be performed or skipped, according to a first random access point (RAP) picture type and regardless of a first leading picture type, when decoding starts from a first RAP picture, the first leading picture following the first RAP picture in decoding order and preceding the first RAP picture in display order, the first RAP picture type being a type of the first RAP picture, the first leading picture type being a type of the first leading picture.

Furthermore, each constituent element may be a circuit. The circuits may form a single circuit as a whole, or may be separate circuits. In addition, each constituent element may be implemented by a general purpose processor or a dedicated processor.

Although only some exemplary embodiments have been described above, the scope of the Claims of the present application is not limited to these embodiments. Those skilled in the art will readily appreciate that various modifications may be made in these exemplary embodiments and that other embodiments may be obtained by arbitrarily combining the constituent elements of the embodiments without materially departing from the novel teachings and advantages of the subject matter recited in the appended Claims. Accordingly, all such modifications and other embodiments are included in the present disclosure.

For example, an image coding apparatus corresponding to the image decoding apparatus above may be implemented. Furthermore, it may be that an image coding and decoding apparatus may include an image coding apparatus and an image decoding apparatus. It may also be that processing which is executed by a particular processing unit may be executed by another processing unit. Furthermore, the order of steps in a process may be changed, and a plurality of processes may be executed in parallel.

### EMBODIMENT 3

The processing described in each of the above embodiments can be simply implemented in an independent computer system, by recording, in a recording medium, a program for implementing the configurations of the moving picture coding method (image coding method) and the moving picture decoding method (image decoding method) described in each of the embodiments. The recording media may be any recording media as long as the program can be recorded, such as a magnetic disk, an optical disk, a magnetic optical disk, an IC card, and a semiconductor memory.

Hereinafter, the applications to the moving picture coding method (image coding method) and the moving picture decoding method (image decoding method) described in each of the embodiments and systems using thereof will be described. The system has a feature of having an image coding and decoding apparatus that includes an image coding apparatus using the image coding method and an image decoding apparatus using the image decoding method. Other configurations in the system can be changed as appropriate depending on the cases.

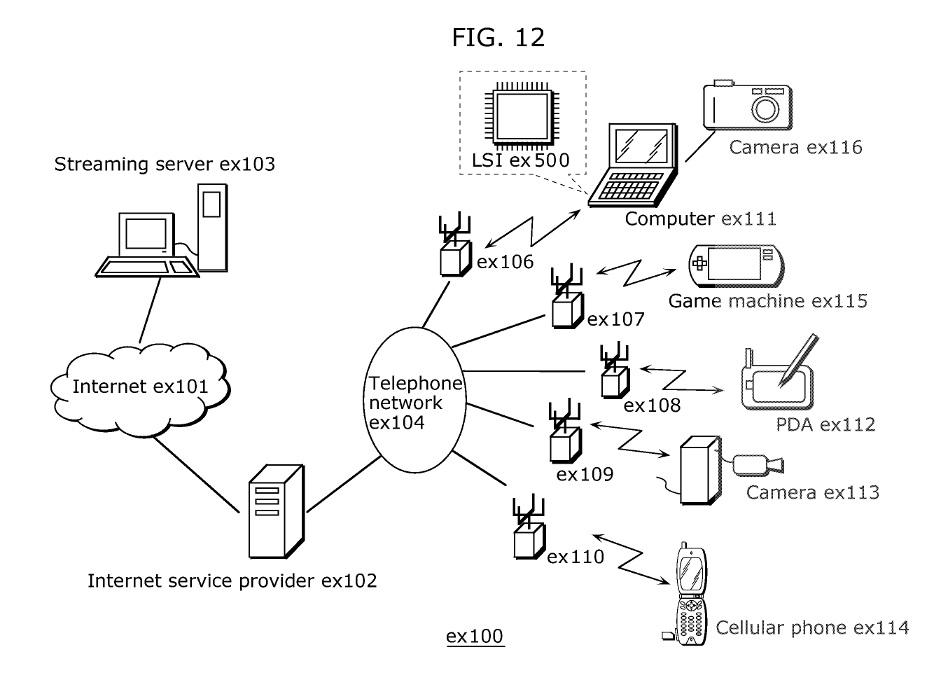

FIG. 12 illustrates an overall configuration of a content providing system ex100 for implementing content distribution services. The area for providing communication services is divided into cells of desired size, and base stations ex106, ex107, ex108, ex109, and ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via the Internet ex101, an Internet service provider ex102, a telephone network ex104, as well as the base stations ex106 to ex110, respectively.

However, the configuration of the content providing system ex100 is not limited to the configuration shown in FIG. 12, and a combination in which any of the elements are connected is acceptable. In addition, each device may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing video. A camera ex116, such as a digital camera, is capable of capturing both still images and video. Furthermore, the cellular phone ex114 may be the one that meets any of the standards such as Global System for Mobile Communications (GSM) (registered trademark), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of images of a live show and others. In such a distribution, a content (for example, video of a music live show) captured by the user using the camera ex113 is coded as described above in each of embodiments (i.e., the camera functions as the image coding apparatus according to an aspect of the present disclosure), and the coded content is transmitted to the streaming server ex103. On the other hand, the streaming server ex103 carries out stream distribution of the transmitted content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data (i.e., functions as the image decoding apparatus according to an aspect of the present disclosure). The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and video captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding video may be integrated into some type of a recording medium (such as a CD-ROM, a flexible disk, and a hard disk) that is readable by the computer ex111 and others, and the coding and decoding processes may be performed using the software. Furthermore, when the cellular phone ex114 is equipped with a camera, the video data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients may receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

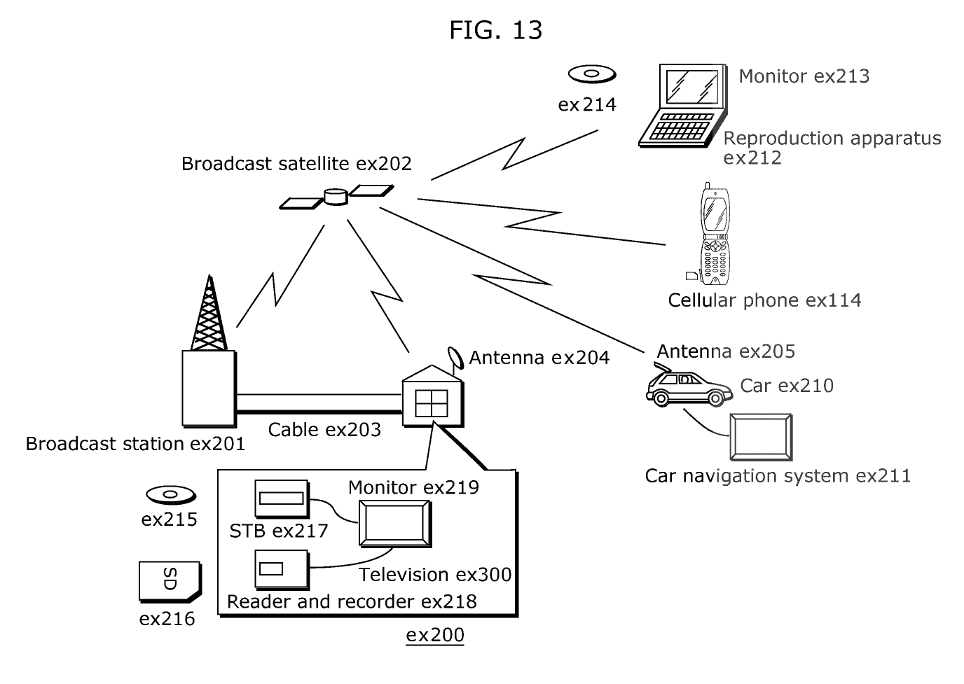

Aside from the example of the content providing system ex100, at least one of the moving picture coding apparatus (image coding apparatus) and the moving picture decoding apparatus (image decoding apparatus) described in each of embodiments may be implemented in a digital broadcasting system ex200 illustrated in FIG. 13. More specifically, a broadcast station ex201 communicates or transmits, via radio waves to a broadcast satellite ex202, multiplexed data obtained by multiplexing audio data and others onto video data. The video data is data coded by the moving picture coding method described in each of embodiments (i.e., data coded by the image coding apparatus according to an aspect of the present disclosure). Upon receipt of the multiplexed data, the broadcast satellite ex202 transmits radio waves for broadcasting. Then, a home-use antenna ex204 with a satellite broadcast reception function receives the radio waves. Next, a device such as a television (receiver) ex300 and a set top box (STB) ex217 decodes the received multiplexed data, and reproduces the decoded data (i.e., functions as the image decoding apparatus according to an aspect of the present disclosure).

Furthermore, a reader/recorder ex218 (i) reads and decodes the multiplexed data recorded on a recording medium ex215, such as a DVD and a BD, or (i) codes video signals in the recording medium ex215, and in some cases, writes data obtained by multiplexing an audio signal on the coded data. The reader/recorder ex218 can include the moving picture decoding apparatus or the moving picture coding apparatus as shown in each of embodiments. In this case, the reproduced video signals are displayed on the monitor ex219, and can be reproduced by another device or system using the recording medium ex215 on which the multiplexed data is recorded. It is also possible to implement the moving picture decoding apparatus in the set top box ex217 connected to the cable ex203 for a cable television or to the antenna ex204 for satellite and/or terrestrial broadcasting, so as to display the video signals on the monitor ex219 of the television ex300. The moving picture decoding apparatus may be implemented not in the set top box but in the television ex300.

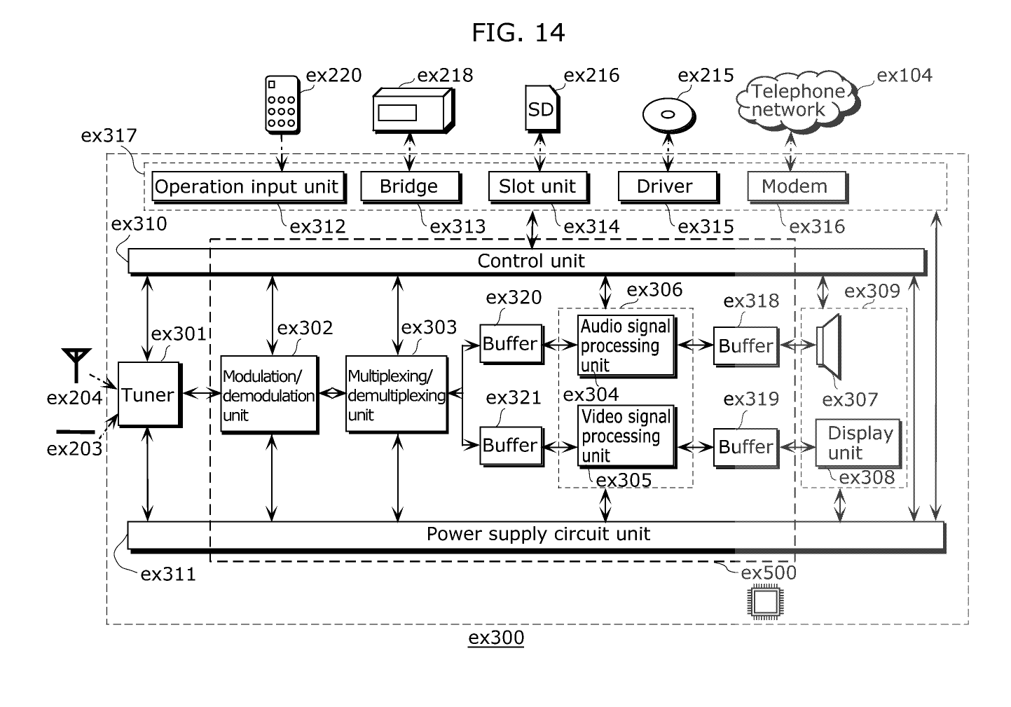

FIG. 14 illustrates the television (receiver) ex300 that uses the moving picture coding method and the moving picture decoding method described in each of embodiments. The television ex300 includes: a tuner ex301 that obtains or provides multiplexed data obtained by multiplexing audio data onto video data, through the antenna ex204 or the cable ex203, etc. that receives a broadcast; a modulation/demodulation unit ex302 that demodulates the received multiplexed data or modulates data into multiplexed data to be supplied outside; and a multiplexing/demultiplexing unit ex303 that demultiplexes the modulated multiplexed data into video data and audio data, or multiplexes video data and audio data coded by a signal processing unit ex306 into data.

The television ex300 further includes: a signal processing unit ex306 including an audio signal processing unit ex304 and a video signal processing unit ex305 that decode audio data and video data and code audio data and video data, respectively (which function as the image coding apparatus and the image decoding apparatus according to the aspects of the present disclosure); and an output unit ex309 including a speaker ex307 that provides the decoded audio signal, and a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, the configuration in which the television ex300 decodes multiplexed data obtained from outside through the antenna ex204 and others and reproduces the decoded data will be described. In the television ex300, upon a user operation through a remote controller ex220 and others, the multiplexing/demultiplexing unit ex303 demultiplexes the multiplexed data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read multiplexed data not through a broadcast and others but from the recording media ex215 and ex216, such as a magnetic disk, an optical disk, and a SD card. Next, a configuration in which the television ex300 codes an audio signal and a video signal, and transmits the data outside or writes the data on a recording medium will be described. In the television ex300, upon a user operation through the remote controller ex220 and others, the audio signal processing unit ex304 codes an audio signal, and the video signal processing unit ex305 codes a video signal, under control of the control unit ex310 using the coding method described in each of embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in the buffers ex320 and ex321, and others so that the signals are reproduced in synchronization with each other. Here, the buffers ex318, ex319, ex320, and ex321 may be plural as illustrated, or at least one buffer may be shared in the television ex300. Furthermore, data may be stored in a buffer so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be capable of only receiving, decoding, and providing outside data but not the coding, multiplexing, and providing outside data.

Furthermore, when the reader/recorder ex218 reads or writes multiplexed data from or on a recording medium, one of the television ex300 and the reader/recorder ex218 may decode or code the multiplexed data, and the television ex300 and the reader/recorder ex218 may share the decoding or coding.

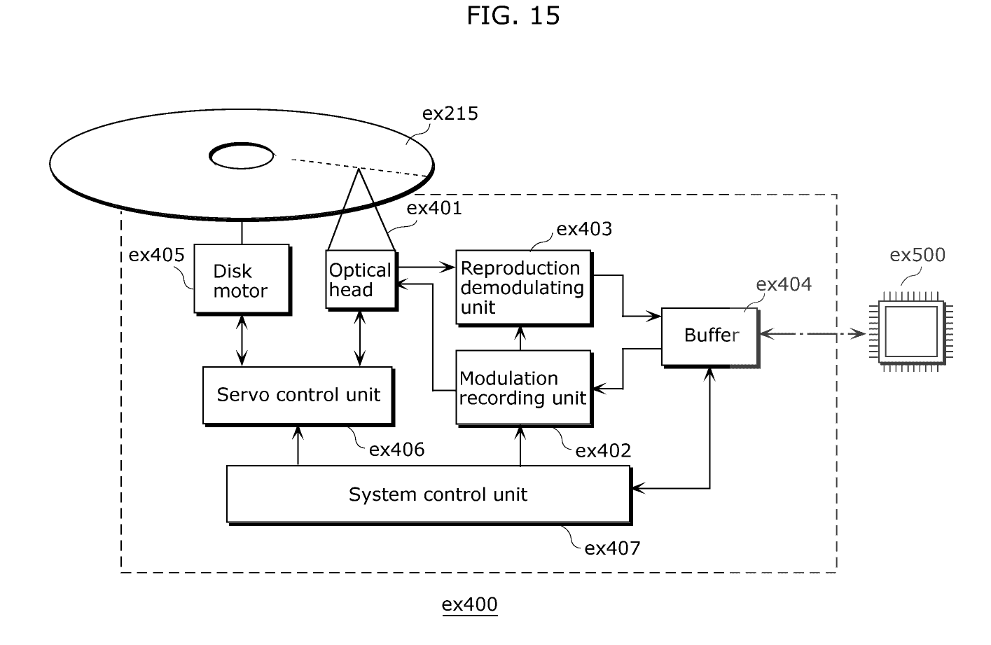

As an example, FIG. 15 illustrates a configuration of an information reproducing/recording unit ex400 when data is read or written from or on an optical disk. The information reproducing/recording unit ex400 includes constituent elements ex401, ex402, ex403, ex404, ex405, ex406, and ex407 to be described hereinafter. The optical head ex401 irradiates a laser spot in a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. The disk motor ex405 rotates the recording medium ex215. The servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

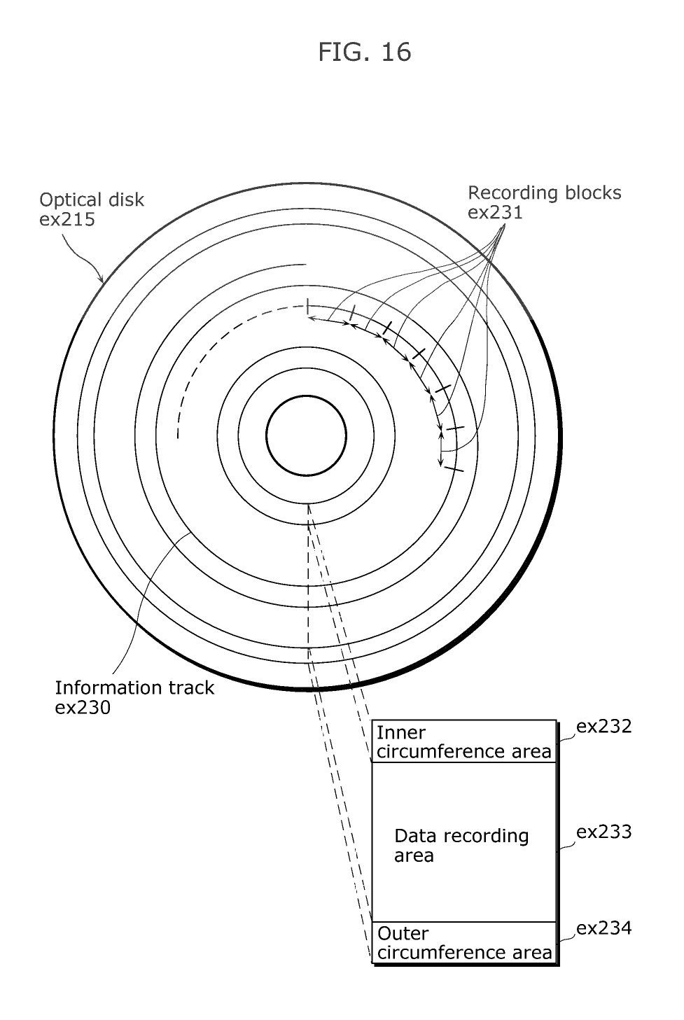

FIG. 16 illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. Reproducing the information track ex230 and reading the address information in an apparatus that records and reproduces data can lead to determination of the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio, coded video data, or multiplexed data obtained by multiplexing the coded audio and video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and for recording information having different layers from various angles.

Furthermore, a car ex210 having an antenna ex205 can receive data from the satellite ex202 and others, and reproduce video on a display device such as a car navigation system ex211 set in the car ex210, in the digital broadcasting system ex200. Here, a configuration of the car navigation system ex211 will be a configuration, for example, including a GPS receiving unit from the configuration illustrated in FIG. 14. The same will be true for the configuration of the computer ex111, the cellular phone ex114, and others.

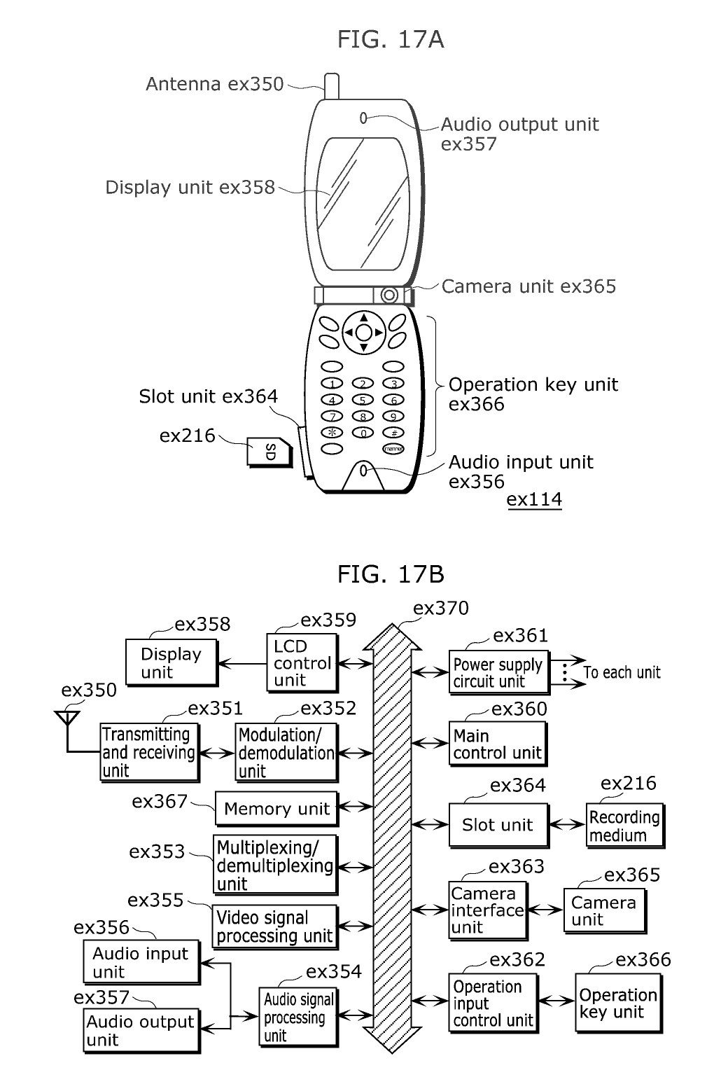

FIG. 17A illustrates the cellular phone ex114 that uses the moving picture coding method and the moving picture decoding method described in embodiments. The cellular phone ex114 includes: an antenna ex350 for transmitting and receiving radio waves through the base station ex110; a camera unit ex365 capable of capturing moving and still images; and a display unit ex358 such as a liquid crystal display for displaying the data such as decoded video captured by the camera unit ex365 or received by the antenna ex350. The cellular phone ex114 further includes: a main body unit including an operation key unit ex366; an audio output unit ex357 such as a speaker for output of audio; an audio input unit ex356 such as a microphone for input of audio; a memory unit ex367 for storing captured video or still pictures, recorded audio, coded or decoded data of the received video, the still pictures, e-mails, or others; and a slot unit ex364 that is an interface unit for a recording medium that stores data in the same manner as the memory unit ex367.

Next, an example of a configuration of the cellular phone ex114 will be described with reference to FIG. 17B. In the cellular phone ex114, a main control unit ex360 designed to control overall each unit of the main body including the display unit ex358 as well as the operation key unit ex366 is connected mutually, via a synchronous bus ex370, to a power supply circuit unit ex361, an operation input control unit ex362, a video signal processing unit ex355, a camera interface unit ex363, a liquid crystal display (LCD) control unit ex359, a modulation/demodulation unit ex352, a multiplexing/demultiplexing unit ex353, an audio signal processing unit ex354, the slot unit ex364, and the memory unit ex367.

When a call-end key or a power key is turned ON by a user's operation, the power supply circuit unit ex361 supplies the respective units with power from a battery pack so as to activate the cell phone ex114.

In the cellular phone ex114, the audio signal processing unit ex354 converts the audio signals collected by the audio input unit ex356 in voice conversation mode into digital audio signals under the control of the main control unit ex360 including a CPU, ROM, and RAM. Then, the modulation/demodulation unit ex352 performs spread spectrum processing on the digital audio signals, and the transmitting and receiving unit ex351 performs digital-to-analog conversion and frequency conversion on the data, so as to transmit the resulting data via the antenna ex350. Also, in the cellular phone ex114, the transmitting and receiving unit ex351 amplifies the data received by the antenna ex350 in voice conversation mode and performs frequency conversion and the analog-to-digital conversion on the data. Then, the modulation/demodulation unit ex352 performs inverse spread spectrum processing on the data, and the audio signal processing unit ex354 converts it into analog audio signals, so as to output them via the audio output unit ex357.

Furthermore, when an e-mail in data communication mode is transmitted, text data of the e-mail inputted by operating the operation key unit ex366 and others of the main body is sent out to the main control unit ex360 via the operation input control unit ex362. The main control unit ex360 causes the modulation/demodulation unit ex352 to perform spread spectrum processing on the text data, and the transmitting and receiving unit ex351 performs the digital-to-analog conversion and the frequency conversion on the resulting data to transmit the data to the base station exit° via the antenna ex350. When an e-mail is received, processing that is approximately inverse to the processing for transmitting an e-mail is performed on the received data, and the resulting data is provided to the display unit ex358. When video, still images, or video and audio in data communication mode is or are transmitted, the video signal processing unit ex355 compresses and codes video signals supplied from the camera unit ex365 using the moving picture coding method shown in each of embodiments (i.e., functions as the image coding apparatus according to the aspect of the present disclosure), and transmits the coded video data to the multiplexing/demultiplexing unit ex353. In contrast, during when the camera unit ex365 captures video, still images, and others, the audio signal processing unit ex354 codes audio signals collected by the audio input unit ex356, and transmits the coded audio data to the multiplexing/demultiplexing unit ex353.

The multiplexing/demultiplexing unit ex353 multiplexes the coded video data supplied from the video signal processing unit ex355 and the coded audio data supplied from the audio signal processing unit ex354, using a predetermined method. Then, the modulation/demodulation unit (modulation/demodulation circuit unit) ex352 performs spread spectrum processing on the multiplexed data, and the transmitting and receiving unit ex351 performs digital-to-analog conversion and frequency conversion on the data so as to transmit the resulting data via the antenna ex350.

When receiving data of a video file which is linked to a Web page and others in data communication mode or when receiving an e-mail with video and/or audio attached, in order to decode the multiplexed data received via the antenna ex350, the multiplexing/demultiplexing unit ex353 demultiplexes the multiplexed data into a video data bit stream and an audio data bit stream, and supplies the video signal processing unit ex355 with the coded video data and the audio signal processing unit ex354 with the coded audio data, through the synchronous bus ex370. The video signal processing unit ex355 decodes the video signal using a moving picture decoding method corresponding to the moving picture coding method shown in each of embodiments (i.e., functions as the image decoding apparatus according to the aspect of the present disclosure), and then the display unit ex358 displays, for instance, the video and still images included in the video file linked to the Web page via the LCD control unit ex359. Furthermore, the audio signal processing unit ex354 decodes the audio signal, and the audio output unit ex357 provides the audio.

Furthermore, similarly to the television ex300, a terminal such as the cellular phone ex114 probably have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus. Although the digital broadcasting system ex200 receives and transmits the multiplexed data obtained by multiplexing audio data onto video data in the description, the multiplexed data may be data obtained by multiplexing not audio data but character data related to video onto video data, and may be not multiplexed data but video data itself.

As such, the moving picture coding method and the moving picture decoding method in each of embodiments can be used in any of the devices and systems described. Thus, the advantages described in each of embodiments can be obtained. Furthermore, various modifications and revisions can be made in any of the embodiments in the present disclosure.

### EMBODIMENT 4

Video data can be generated by switching, as necessary, between (i) the moving picture coding method or the moving picture coding apparatus shown in each of embodiments and (ii) a moving picture coding method or a moving picture coding apparatus in conformity with a different standard, such as MPEG-2, MPEG-4 AVC, and VC-1.

Here, when a plurality of video data that conforms to the different standards is generated and is then decoded, the decoding methods need to be selected to conform to the different standards. However, since to which standard each of the plurality of the video data to be decoded conform cannot be detected, there is a problem that an appropriate decoding method cannot be selected.

In order to solve the problem, multiplexed data obtained by multiplexing audio data and others onto video data has a structure including identification information indicating to which standard the video data conforms. The specific structure of the multiplexed data including the video data generated in the moving picture coding method and by the moving picture coding apparatus shown in each of embodiments will be hereinafter described. The multiplexed data is a digital stream in the MPEG-2 Transport Stream format.

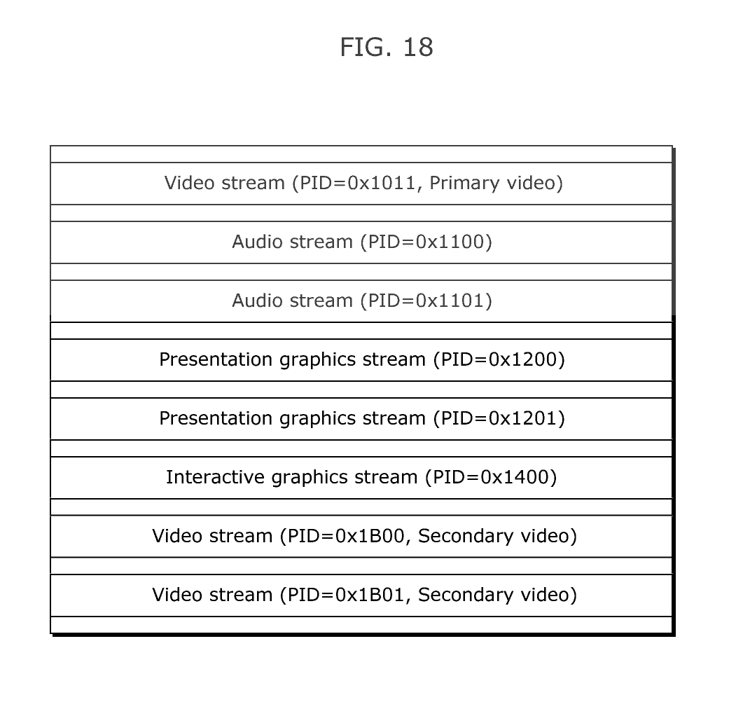

FIG. 18 illustrates a structure of the multiplexed data. As illustrated in FIG. 18, the multiplexed data can be obtained by multiplexing at least one of a video stream, an audio stream, a presentation graphics stream (PG), and an interactive graphics stream. The video stream represents primary video and secondary video of a movie, the audio stream (IG) represents a primary audio part and a secondary audio part to be mixed with the primary audio part, and the presentation graphics stream represents subtitles of the movie. Here, the primary video is normal video to be displayed on a screen, and the secondary video is video to be displayed on a smaller window in the primary video. Furthermore, the interactive graphics stream represents an interactive screen to be generated by arranging the GUI components on a screen. The video stream is coded in the moving picture coding method or by the moving picture coding apparatus shown in each of embodiments, or in a moving picture coding method or by a moving picture coding apparatus in conformity with a conventional standard, such as MPEG-2, MPEG-4 AVC, and VC-1. The audio stream is coded in accordance with a standard, such as Dolby-AC-3, Dolby Digital Plus, MLP, DTS, DTS-HD, and linear PCM.

Each stream included in the multiplexed data is identified by PID. For example, 0x1011 is allocated to the video stream to be used for video of a movie, 0x1100 to 0x111F are allocated to the audio streams, 0x1200 to 0x121F are allocated to the presentation graphics streams, 0x1400 to 0x141F are allocated to the interactive graphics streams, 0x1B00 to 0x1B1F are allocated to the video streams to be used for secondary video of the movie, and 0x1A00 to 0x1A1F are allocated to the audio streams to be used for the secondary audio to be mixed with the primary audio.

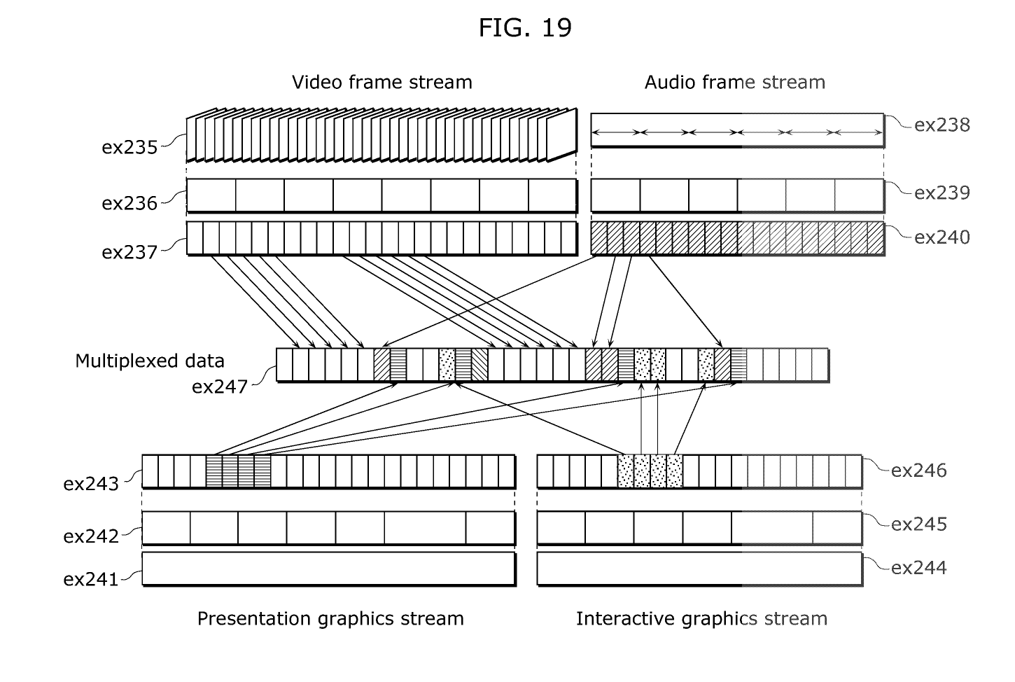

FIG. 19 schematically illustrates how data is multiplexed. First, a video stream ex235 composed of video frames and an audio stream ex238 composed of audio frames are transformed into a stream of PES packets ex236 and a stream of PES packets ex239, and further into TS packets ex237 and TS packets ex240, respectively. Similarly, data of a presentation graphics stream ex241 and data of an interactive graphics stream ex244 are transformed into a stream of PES packets ex242 and a stream of PES packets ex245, and further into TS packets ex243 and TS packets ex246, respectively. These TS packets are multiplexed into a stream to obtain multiplexed data ex247.

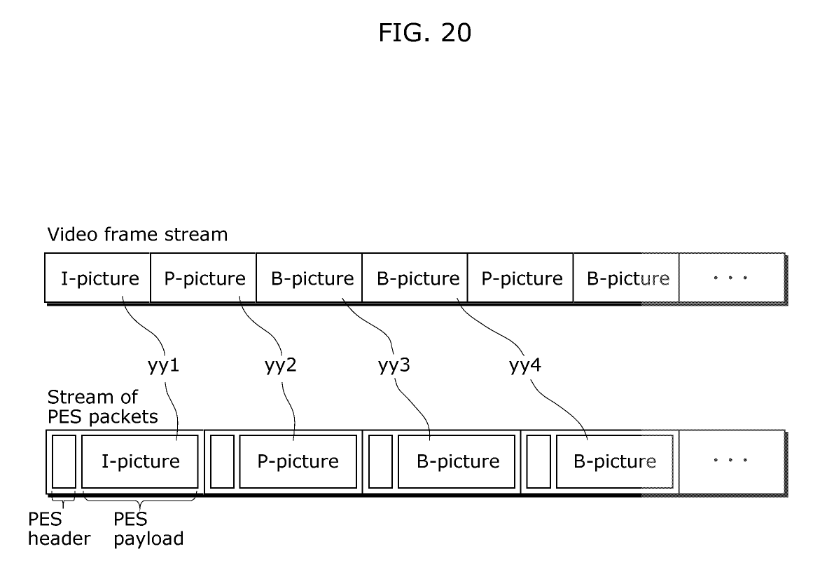

FIG. 20 illustrates how a video stream is stored in a stream of PES packets in more detail. The first bar in FIG. 20 shows a video frame stream in a video stream. The second bar shows the stream of PES packets. As indicated by arrows denoted as yy1, yy2, yy3, and yy4 in FIG. 20, the video stream is divided into pictures as I pictures, B pictures, and P pictures each of which is a video presentation unit, and the pictures are stored in a payload of each of the PES packets. Each of the PES packets has a PES header, and the PES header stores a Presentation Time-Stamp (PTS) indicating a display time of the picture, and a Decoding Time-Stamp (DTS) indicating a decoding time of the picture.

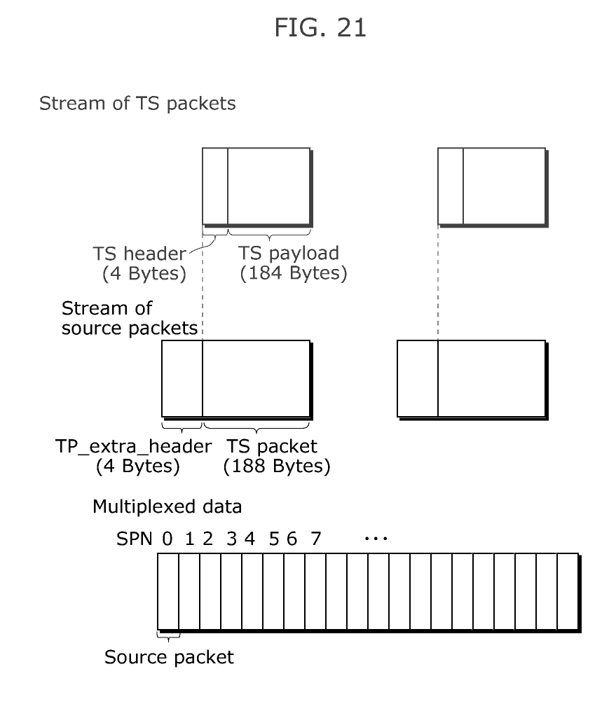

FIG. 21 illustrates a format of TS packets to be finally written on the multiplexed data. Each of the TS packets is a 188-byte fixed length packet including a 4-byte TS header having information, such as a PID for identifying a stream and a 184-byte TS payload for storing data. The PES packets are divided, and stored in the TS payloads, respectively. When a BD ROM is used, each of the TS packets is given a 4-byte TP_Extra_Header, thus resulting in 192-byte source packets. The source packets are written on the multiplexed data. The TP_Extra_Header stores information such as an Arrival_Time_Stamp (ATS). The ATS shows a transfer start time at which each of the TS packets is to be transferred to a PID filter. The source packets are arranged in the multiplexed data as shown at the bottom of FIG. 21. The numbers incrementing from the head of the multiplexed data are called source packet numbers (SPNs).

Each of the TS packets included in the multiplexed data includes not only streams of audio, video, subtitles and others, but also a Program Association Table (PAT), a Program Map Table (PMT), and a Program Clock Reference (PCR). The PAT shows what a PID in a PMT used in the multiplexed data indicates, and a PID of the PAT itself is registered as zero. The PMT stores PIDs of the streams of video, audio, subtitles and others included in the multiplexed data, and attribute information of the streams corresponding to the PIDs. The PMT also has various descriptors relating to the multiplexed data. The descriptors have information such as copy control information showing whether copying of the multiplexed data is permitted or not. The PCR stores STC time information corresponding to an ATS showing when the PCR packet is transferred to a decoder, in order to achieve synchronization between an Arrival Time Clock (ATC) that is a time axis of ATSs, and an System Time Clock (STC) that is a time axis of PTSs and DTSs.

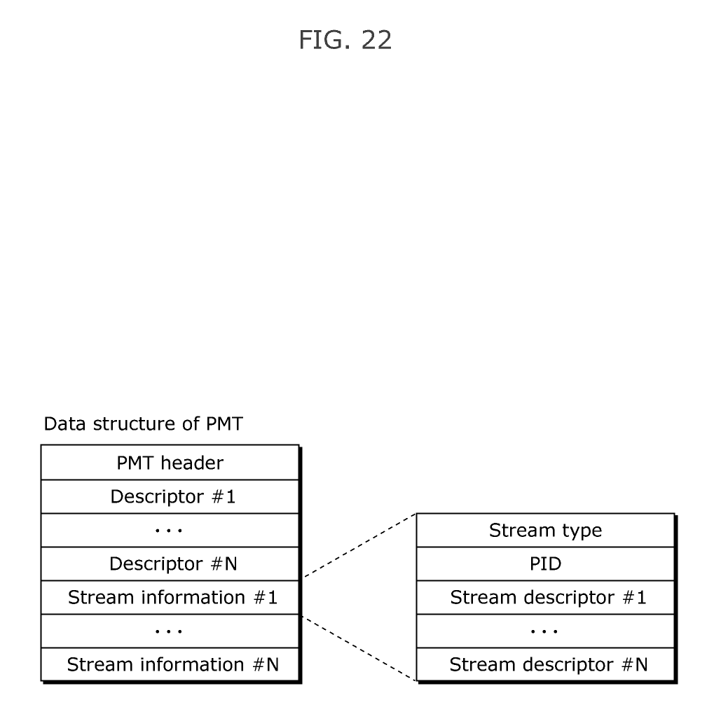

FIG. 22 illustrates the data structure of the PMT in detail. A PMT header is disposed at the top of the PMT. The PMT header describes the length of data included in the PMT and others. A plurality of descriptors relating to the multiplexed data is disposed after the PMT header. Information such as the copy control information is described in the descriptors. After the descriptors, a plurality of pieces of stream information relating to the streams included in the multiplexed data is disposed. Each piece of stream information includes stream descriptors each describing information, such as a stream type for identifying a compression codec of a stream, a stream PID, and stream attribute information (such as a frame rate or an aspect ratio). The stream descriptors are equal in number to the number of streams in the multiplexed data. The stream descriptors are equal in number to the number of streams in the multiplexed data.

When the multiplexed data is recorded on a recording medium and others, it is recorded together with multiplexed data information files.

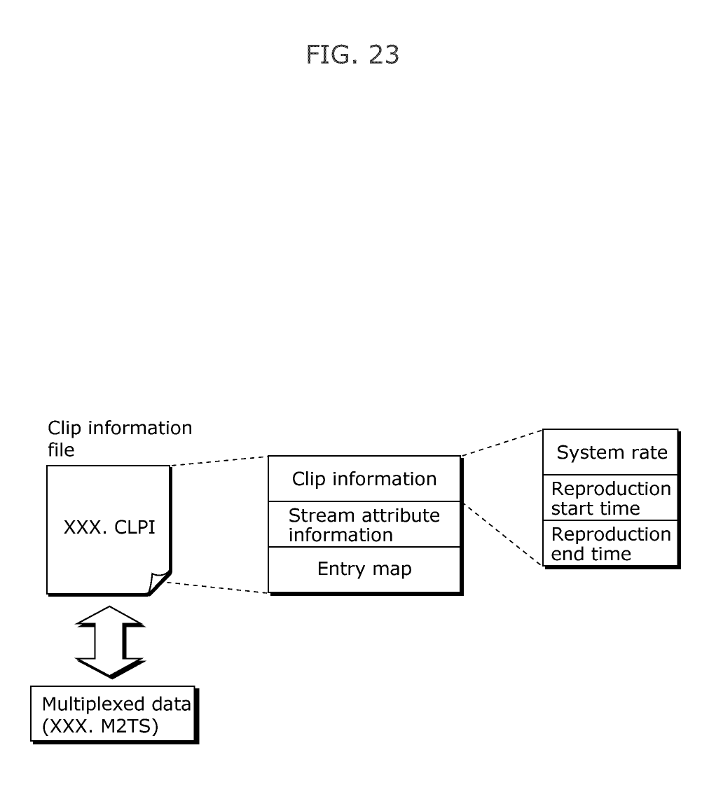

Each of the multiplexed data information files is management information of the multiplexed data as shown in FIG. 23. The multiplexed data information files are in one to one correspondence with the multiplexed data, and each of the files includes multiplexed data information, stream attribute information, and an entry map.

As illustrated in FIG. 23, the multiplexed data information includes a system rate, a reproduction start time, and a reproduction end time. The system rate indicates the maximum transfer rate at which a system target decoder to be described later transfers the multiplexed data to a PID filter. The intervals of the ATSs included in the multiplexed data are set to not higher than a system rate. The reproduction start time indicates a PTS in a video frame at the head of the multiplexed data. An interval of one frame is added to a PTS in a video frame at the end of the multiplexed data, and the PTS is set to the reproduction end time.

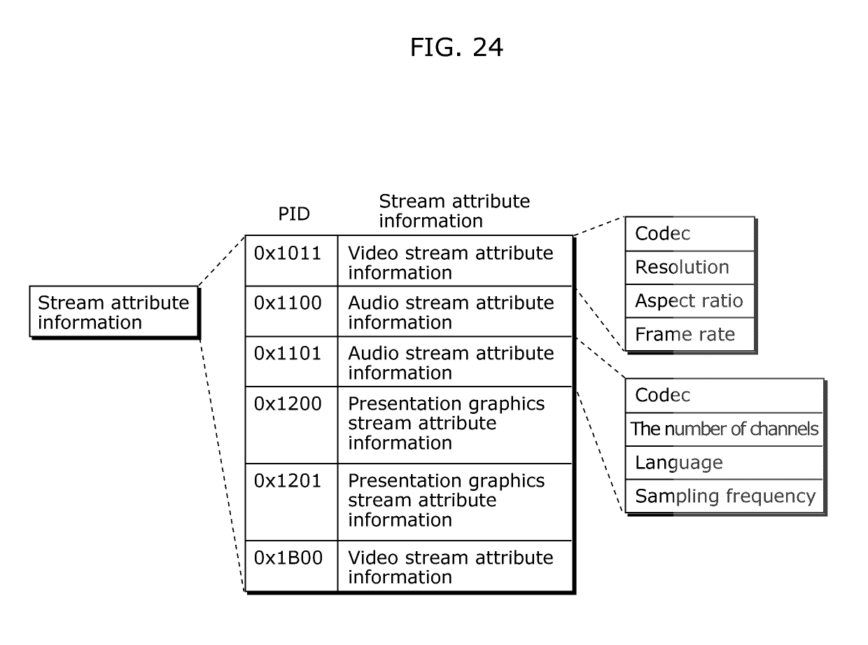

As shown in FIG. 24, a piece of attribute information is registered in the stream attribute information, for each PID of each stream included in the multiplexed data. Each piece of attribute information has different information depending on whether the corresponding stream is a video stream, an audio stream, a presentation graphics stream, or an interactive graphics stream. Each piece of video stream attribute information carries information including what kind of compression codec is used for compressing the video stream, and the resolution, aspect ratio and frame rate of the pieces of picture data that is included in the video stream. Each piece of audio stream attribute information carries information including what kind of compression codec is used for compressing the audio stream, how many channels are included in the audio stream, which language the audio stream supports, and how high the sampling frequency is. The video stream attribute information and the audio stream attribute information are used for initialization of a decoder before the player plays back the information.

In the present embodiment, the multiplexed data to be used is of a stream type included in the PMT. Furthermore, when the multiplexed data is recorded on a recording medium, the video stream attribute information included in the multiplexed data information is used. More specifically, the moving picture coding method or the moving picture coding apparatus described in each of embodiments includes a step or a unit for allocating unique information indicating video data generated by the moving picture coding method or the moving picture coding apparatus in each of embodiments, to the stream type included in the PMT or the video stream attribute information. With the configuration, the video data generated by the moving picture coding method or the moving picture coding apparatus described in each of embodiments can be distinguished from video data that conforms to another standard.

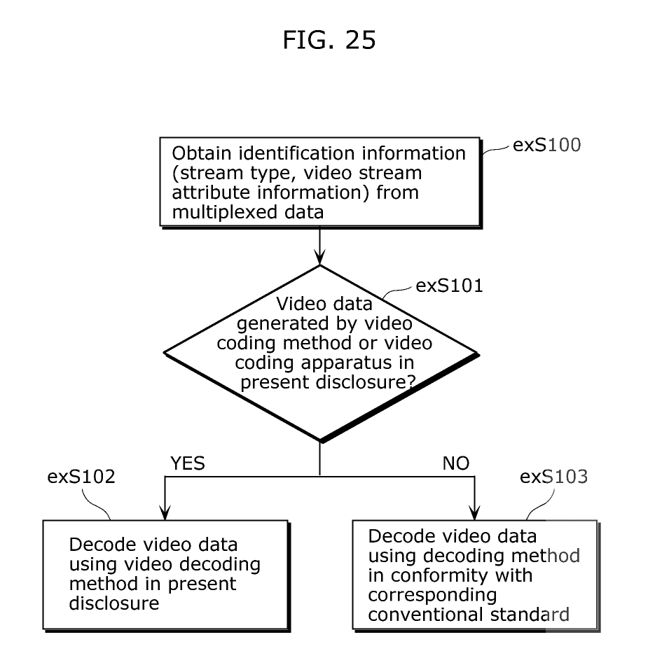

Furthermore, FIG. 25 illustrates steps of the moving picture decoding method according to the present embodiment. In Step exS100, the stream type included in the PMT or the video stream attribute information included in the multiplexed data information is obtained from the multiplexed data. Next, in Step exS101, it is determined whether or not the stream type or the video stream attribute information indicates that the multiplexed data is generated by the moving picture coding method or the moving picture coding apparatus in each of embodiments. When it is determined that the stream type or the video stream attribute information indicates that the multiplexed data is generated by the moving picture coding method or the moving picture coding apparatus in each of embodiments, in Step exS102, decoding is performed by the moving picture decoding method in each of embodiments. Furthermore, when the stream type or the video stream attribute information indicates conformance to the conventional standards, such as MPEG-2, MPEG-4 AVC, and VC-1, in Step exS103, decoding is performed by a moving picture decoding method in conformity with the conventional standards.

As such, allocating a new unique value to the stream type or the video stream attribute information enables determination whether or not the moving picture decoding method or the moving picture decoding apparatus that is described in each of embodiments can perform decoding. Even when multiplexed data that conforms to a different standard is input, an appropriate decoding method or apparatus can be selected. Thus, it becomes possible to decode information without any error. Furthermore, the moving picture coding method or apparatus, or the moving picture decoding method or apparatus in the present embodiment can be used in the devices and systems described above.

### EMBODIMENT 5

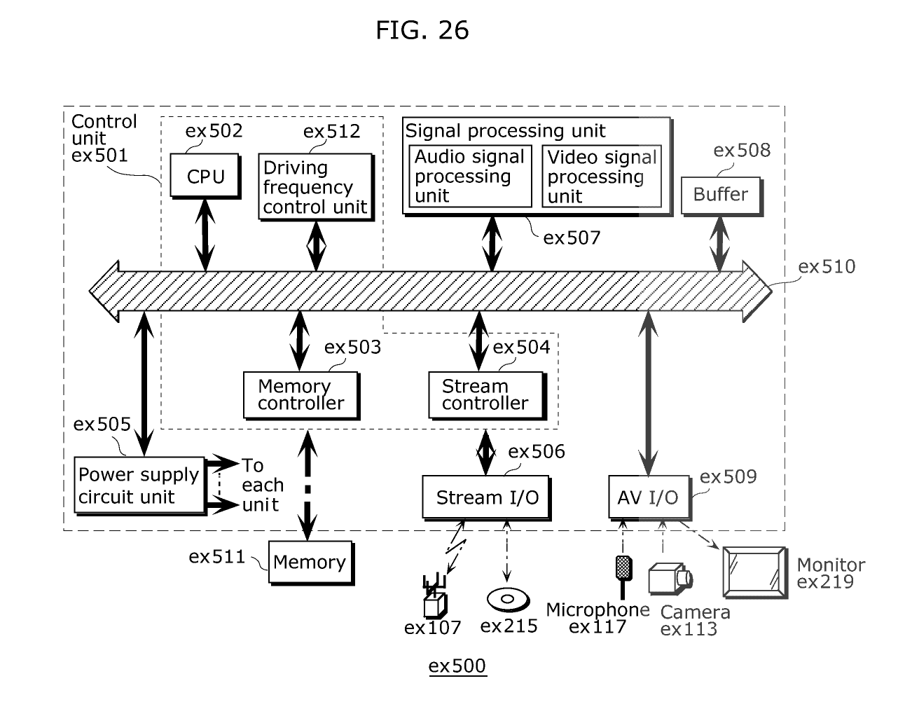

Each of the moving picture coding method, the moving picture coding apparatus, the moving picture decoding method, and the moving picture decoding apparatus in each of embodiments is typically achieved in the form of an integrated circuit or a Large Scale Integrated (LSI) circuit. As an example of the LSI, FIG. 26 illustrates a configuration of the LSI ex500 that is made into one chip. The LSI ex500 includes elements ex501, ex502, ex503, ex504, ex505, ex506, ex507, ex508, and ex509 to be described below, and the elements are connected to each other through a bus ex510. The power supply circuit unit ex505 is activated by supplying each of the elements with power when the power supply circuit unit ex505 is turned on.

For example, when coding is performed, the LSI ex500 receives an AV signal from a microphone ex117, a camera ex113, and others through an AV IO ex509 under control of a control unit ex501 including a CPU ex502, a memory controller ex503, a stream controller ex504, and a driving frequency control unit ex512. The received AV signal is temporarily stored in an external memory ex511, such as an SDRAM. Under control of the control unit ex501, the stored data is segmented into data portions according to the processing amount and speed to be transmitted to a signal processing unit ex507. Then, the signal processing unit ex507 codes an audio signal and/or a video signal. Here, the coding of the video signal is the coding described in each of embodiments. Furthermore, the signal processing unit ex507 sometimes multiplexes the coded audio data and the coded video data, and a stream JO ex506 provides the multiplexed data outside. The provided multiplexed data is transmitted to the base station ex107, or written on the recording medium ex215. When data sets are multiplexed, the data should be temporarily stored in the buffer ex508 so that the data sets are synchronized with each other.

Although the memory ex511 is an element outside the LSI ex500, it may be included in the LSI ex500. The buffer ex508 is not limited to one buffer, but may be composed of buffers. Furthermore, the LSI ex500 may be made into one chip or a plurality of chips.

Furthermore, although the control unit ex501 includes the CPU ex502, the memory controller ex503, the stream controller ex504, the driving frequency control unit ex512, the configuration of the control unit ex501 is not limited to such. For example, the signal processing unit ex507 may further include a CPU. Inclusion of another CPU in the signal processing unit ex507 can improve the processing speed. Furthermore, as another example, the CPU ex502 may serve as or be a part of the signal processing unit ex507, and, for example, may include an audio signal processing unit. In such a case, the control unit ex501 includes the signal processing unit ex507 or the CPU ex502 including a part of the signal processing unit ex507.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSIs or a reconfigurable processor that allows re-configuration of the connection or configuration of an LSI can be used for the same purpose. Such a programmable logic device can typically execute the moving picture coding method and/or the moving picture decoding method according to any of the above embodiments, by loading or reading from a memory or the like one or more programs that are included in software or firmware.

In the future, with advancement in semiconductor technology, a brand-new technology may replace LSI. The functional blocks can be integrated using such a technology. The possibility is that the present disclosure is applied to biotechnology.

### EMBODIMENT 6

When video data generated in the moving picture coding method or by the moving picture coding apparatus described in each of embodiments is decoded, compared to when video data that conforms to a conventional standard, such as MPEG-2, MPEG-4 AVC, and VC-1 is decoded, the processing amount probably increases. Thus, the LSI ex500 needs to be set to a driving frequency higher than that of the CPU ex502 to be used when video data in conformity with the conventional standard is decoded. However, when the driving frequency is set higher, there is a problem that the power consumption increases.

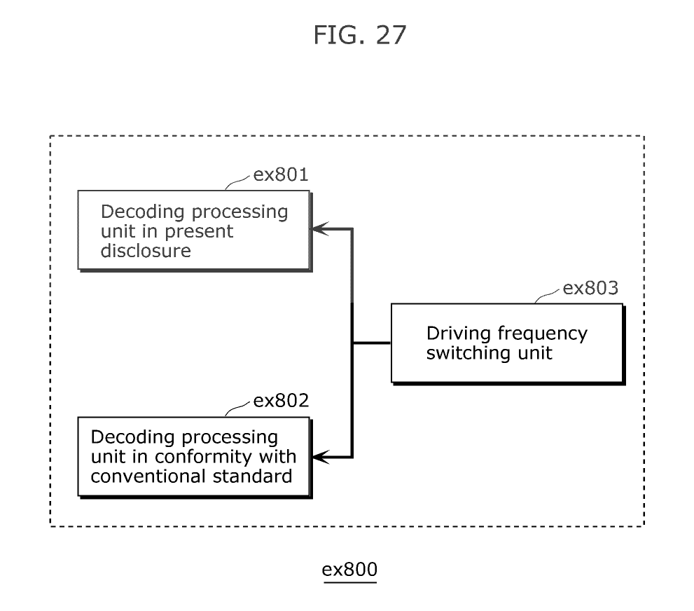

In order to solve the problem, the moving picture decoding apparatus, such as the television ex300 and the LSI ex500 is configured to determine to which standard the video data conforms, and switch between the driving frequencies according to the determined standard. FIG. 27 illustrates a configuration ex800 in the present embodiment. A driving frequency switching unit ex803 sets a driving frequency to a higher driving frequency when video data is generated by the moving picture coding method or the moving picture coding apparatus described in each of embodiments. Then, the driving frequency switching unit ex803 instructs a decoding processing unit ex801 that executes the moving picture decoding method described in each of embodiments to decode the video data.

When the video data conforms to the conventional standard, the driving frequency switching unit ex803 sets a driving frequency to a lower driving frequency than that of the video data generated by the moving picture coding method or the moving picture coding apparatus described in each of embodiments. Then, the driving frequency switching unit ex803 instructs the decoding processing unit ex802 that conforms to the conventional standard to decode the video data.

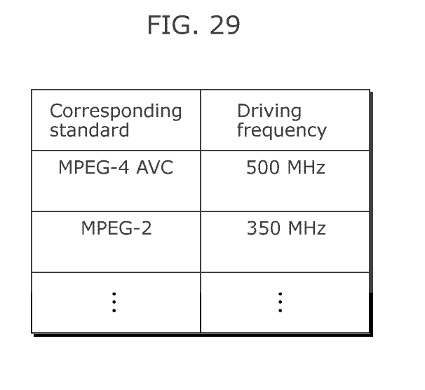

More specifically, the driving frequency switching unit ex803 includes the CPU ex502 and the driving frequency control unit ex512 in FIG. 26. Here, each of the decoding processing unit ex801 that executes the moving picture decoding method described in each of embodiments and the decoding processing unit ex802 that conforms to the conventional standard corresponds to the signal processing unit ex507 in FIG. 26. The CPU ex502 determines to which standard the video data conforms. Then, the driving frequency control unit ex512 determines a driving frequency based on a signal from the CPU ex502. Furthermore, the signal processing unit ex507 decodes the video data based on the signal from the CPU ex502. For example, the identification information described in Embodiment 4 is probably used for identifying the video data. The identification information is not limited to the one described in Embodiment 4 but may be any information as long as the information indicates to which standard the video data conforms. For example, when which standard video data conforms to can be determined based on an external signal for determining that the video data is used for a television or a disk, etc., the determination may be made based on such an external signal. Furthermore, the CPU ex502 selects a driving frequency based on, for example, a look-up table in which the standards of the video data are associated with the driving frequencies as shown in FIG. 29.

The driving frequency can be selected by storing the look-up table in the buffer ex508 and in an internal memory of an LSI, and with reference to the look-up table by the CPU ex502.

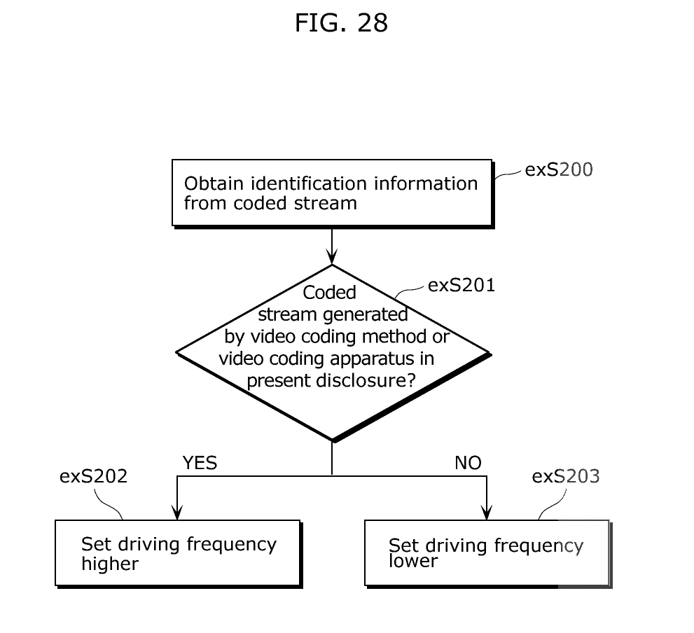

FIG. 28 illustrates steps for executing a method in the present embodiment. First, in Step exS200, the signal processing unit ex507 obtains identification information from the multiplexed data. Next, in Step exS201, the CPU ex502 determines whether or not the video data is generated by the coding method and the coding apparatus described in each of embodiments, based on the identification information. When the video data is generated by the moving picture coding method and the moving picture coding apparatus described in each of embodiments, in Step exS202, the CPU ex502 transmits a signal for setting the driving frequency to a higher driving frequency to the driving frequency control unit ex512. Then, the driving frequency control unit ex512 sets the driving frequency to the higher driving frequency. On the other hand, when the identification information indicates that the video data conforms to the conventional standard, such as MPEG-2, MPEG-4 AVC, and VC-1, in Step exS203, the CPU ex502 transmits a signal for setting the driving frequency to a lower driving frequency to the driving frequency control unit ex512. Then, the driving frequency control unit ex512 sets the driving frequency to the lower driving frequency than that in the case where the video data is generated by the moving picture coding method and the moving picture coding apparatus described in each of embodiment.

Furthermore, along with the switching of the driving frequencies, the power conservation effect can be improved by changing the voltage to be applied to the LSI ex500 or an apparatus including the LSI ex500. For example, when the driving frequency is set lower, the voltage to be applied to the LSI ex500 or the apparatus including the LSI ex500 is probably set to a voltage lower than that in the case where the driving frequency is set higher.

Furthermore, when the processing amount for decoding is larger, the driving frequency may be set higher, and when the processing amount for decoding is smaller, the driving frequency may be set lower as the method for setting the driving frequency. Thus, the setting method is not limited to the ones described above. For example, when the processing amount for decoding video data in conformity with MPEG-4 AVC is larger than the processing amount for decoding video data generated by the moving picture coding method and the moving picture coding apparatus described in each of embodiments, the driving frequency is probably set in reverse order to the setting described above.

Furthermore, the method for setting the driving frequency is not limited to the method for setting the driving frequency lower. For example, when the identification information indicates that the video data is generated by the moving picture coding method and the moving picture coding apparatus described in each of embodiments, the voltage to be applied to the LSI ex500 or the apparatus including the LSI ex500 is probably set higher. When the identification information indicates that the video data conforms to the conventional standard, such as MPEG-2, MPEG-4 AVC, and VC-1, the voltage to be applied to the LSI ex500 or the apparatus including the LSI ex500 is probably set lower. As another example, when the identification information indicates that the video data is generated by the moving picture coding method and the moving picture coding apparatus described in each of embodiments, the driving of the CPU ex502 does not probably have to be suspended. When the identification information indicates that the video data conforms to the conventional standard, such as MPEG-2, MPEG-4 AVC, and VC-1, the driving of the CPU ex502 is probably suspended at a given time because the CPU ex502 has extra processing capacity. Even when the identification information indicates that the video data is generated by the moving picture coding method and the moving picture coding apparatus described in each of embodiments, in the case where the CPU ex502 has extra processing capacity, the driving of the CPU ex502 is probably suspended at a given time. In such a case, the suspending time is probably set shorter than that in the case where when the identification information indicates that the video data conforms to the conventional standard, such as MPEG-2, MPEG-4 AVC, and VC-1.

Accordingly, the power conservation effect can be improved by switching between the driving frequencies in accordance with the standard to which the video data conforms. Furthermore, when the LSI ex500 or the apparatus including the LSI ex500 is driven using a battery, the battery life can be extended with the power conservation effect.

### EMBODIMENT 7

There are cases where a plurality of video data that conforms to different standards, is provided to the devices and systems, such as a television and a cellular phone. In order to enable decoding the plurality of video data that conforms to the different standards, the signal processing unit ex507 of the LSI ex500 needs to conform to the different standards. However, the problems of increase in the scale of the circuit of the LSI ex500 and increase in the cost arise with the individual use of the signal processing units ex507 that conform to the respective standards.

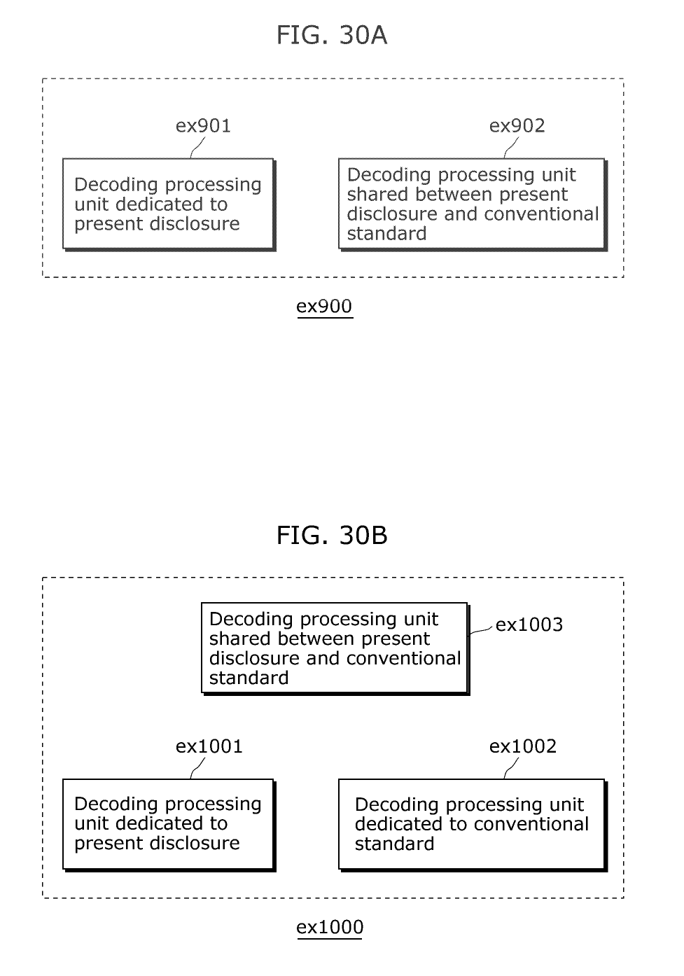

In order to solve the problem, what is conceived is a configuration in which the decoding processing unit for implementing the moving picture decoding method described in each of embodiments and the decoding processing unit that conforms to the conventional standard, such as MPEG-2, MPEG-4 AVC, and VC-1 are partly shared. Ex900 in FIG. 30A shows an example of the configuration. For example, the moving picture decoding method described in each of embodiments and the moving picture decoding method that conforms to MPEG-4 AVC have, partly in common, the details of processing, such as entropy coding, inverse quantization, deblocking filtering, and motion compensated prediction. The details of processing to be shared probably include use of a decoding processing unit ex902 that conforms to MPEG-4 AVC. In contrast, a dedicated decoding processing unit ex901 that does not confirm to MPEG-4 AVC is probably used for other processing unique to an aspect of the present disclosure. Since the aspect of the present disclosure is characterized by system decoding in particular, for example, the dedicated decoding processing unit ex901 is used for system decoding. Otherwise, the decoding processing unit is probably shared for one of the entropy decoding, inverse quantization, deblocking filtering, and motion compensation, or all of the processing. The decoding processing unit for implementing the moving picture decoding method described in each of embodiments may be shared for the processing to be shared, and a dedicated decoding processing unit may be used for processing unique to that of MPEG-4 AVC.

Furthermore, ex1000 in FIG. 30B shows another example in that processing is partly shared. This example uses a configuration including a dedicated decoding processing unit ex1001 that supports the processing unique to an aspect of the present disclosure, a dedicated decoding processing unit ex1002 that supports the processing unique to another conventional standard, and a decoding processing unit ex1003 that supports processing to be shared between the moving picture decoding method according to the aspect of the present disclosure and the conventional moving picture decoding method. Here, the dedicated decoding processing units ex1001 and ex1002 are not necessarily specialized for the processing according to the aspect of the present disclosure and the processing of the conventional standard, respectively, and may be the ones capable of implementing general processing. Furthermore, the configuration of the present embodiment can be implemented by the LSI ex500.

As such, reducing the scale of the circuit of an LSI and reducing the cost are possible by sharing the decoding processing unit for the processing to be shared between the moving picture decoding method according to the aspect of the present disclosure and the moving picture decoding method in conformity with the conventional standard.

### INDUSTRIAL APPLICABILITY

The present disclosure is applicable to, for example, television receivers, digital video recorders, car navigation systems, mobile phones, digital cameras, and digital video cameras.

1. An image decoding method comprising
controlling whether decoding of a first leading picture is to be performed or skipped, according to a first random access point (RAP) picture type and regardless of a first leading picture type, when decoding starts from a first RAP picture, the first leading picture following the first RAP picture in decoding order and preceding the first RAP picture in display order, the first RAP picture type being a type of the first RAP picture, the first leading picture type being a type of the first leading picture.

2. The image decoding method according to claim 1,
wherein the first RAP picture type is one of a plurality of RAP picture types,
the RAP picture types include:
(i) a clean random access (CRA) picture type which is a type corresponding to a RAP picture which allows a picture following the RAP picture in decoding order to refer to a picture preceding the RAP picture in decoding order;
(ii) a broken link access (BLA) picture type which is a type corresponding to a RAP picture which has a possibility that reference from a picture following the RAP picture in decoding order to a picture preceding the RAP picture in decoding order is broken; and
(iii) an instantaneous decoding refresh (IDR) picture type which is a type corresponding to a RAP picture which prohibits a picture following the RAP picture in decoding order from referring to a picture preceding the RAP picture in decoding order, the first leading picture type is one of a plurality of leading picture types,
the leading picture types include:
(i) a decodable leading picture (DLP) type which is a type corresponding to a leading picture that is decodable in decoding starting from a RAP picture; and
(ii) a tagged for discard (TFD) picture type which is a type corresponding to a leading picture that is not ensured to be decodable in decoding starting from a RAP picture, and
in the controlling, when decoding starts from the first RAP picture, whether decoding of the first leading picture is to be performed or skipped is controlled according to which one of the RAP picture types is the first RAP picture type and regardless of which one of the leading picture types is the first leading picture type.

3. The image decoding method according to claim 2,
wherein, in the controlling, when (i) decoding starts from the first RAP picture and (ii) the first RAP picture type is the CRA picture type or the BLA picture type, decoding of the first leading picture is skipped regardless of whether the first leading picture type is the DLP picture type or the TFD picture type.

4. The image decoding method according to claim 2,
wherein, in the controlling, when (i) decoding starts from the first RAP picture and (ii) the first RAP picture type is the IDR picture type, decoding of the first leading picture is performed regardless of whether the first leading picture type is the DLP picture type or the TFD picture type.

5. The image decoding method according to claim 2,
wherein the CRA picture type includes a first CRA picture type,
the first CRA picture type is a type corresponding to a RAP picture of the CRA picture type having a leading picture of the TFD picture type,
the BLA picture type includes a first BLA picture type, a second BLA picture type, and a third BLA picture type,
the first BLA picture type is a type corresponding to a RAP picture of the BLA picture type having a leading picture of the TFD picture type,
the second BLA picture type is a type corresponding to a RAP picture of the BLA picture type having no leading picture of the TFD picture type and having a leading picture of the DLP picture type,
the third BLA picture type is a type corresponding to a RAP picture of the BLA picture type having no leading picture,
the IDR picture type includes a first IDR picture type and a second IDR picture type,
the first IDR picture type is a type corresponding to a RAP picture of the IDR picture type having no leading picture of the TFD picture type and having a leading picture of the DLP picture type,
the second IDR picture type is a type corresponding to a RAP picture of the IDR picture type having no leading picture,
the first RAP picture type is one of the RAP picture types including the first CRA picture type, the first BLA picture type, the second BLA picture type, the third BLA picture type, the first IDR picture type, and the second IDR picture type, and
in the controlling, when decoding starts from the first RAP picture, whether decoding of the first leading picture is to be performed or skipped is controlled according to which one of the RAP picture types is the first RAP picture type and regardless of which one of the leading picture types is the first leading picture type.

6. The image decoding method according to claim 5,
wherein, in the controlling, when (i) decoding starts from the first RAP picture and (ii) the first RAP picture type is one of the first CRA picture type, the first BLA picture type or the second BLA picture type, decoding of the first leading picture is skipped regardless of whether the first leading picture type is the DLP picture type or the TFD picture type.

7. The image decoding method according to claim 5,
wherein, in the controlling, when (i) decoding starts from the first RAP picture and (ii) the first RAP picture type is the first IDR picture type, decoding of the first leading picture is performed regardless of whether the first leading picture type is the DLP picture type or the TFD picture type.

8. The image decoding method according to claim 2,
wherein, in the controlling, when (i) decoding starts from the first RAP picture and (ii) the first RAP picture type is a predetermined first type, decoding of the first leading picture of the DLP picture type is skipped.

9. The image decoding method according to claim 2,
wherein, in the controlling, when (i) decoding starts from the first RAP picture and (ii) the first RAP picture type is a predetermined second type, decoding of the first leading picture of the TFD picture type is performed.

10. The image decoding method according to claim 1,
wherein, in the controlling, when (i) decoding starts from the first RAP picture and (ii) the first RAP picture type is a predetermined first type, a skip-flag is set, the skip-flag indicating that decoding of a leading picture is to be skipped, and
in a case where the skip-flag is set, decoding of the first leading picture is skipped.

11. The image decoding method according to claim 1,
wherein, in the controlling, when (i) decoding starts from the first RAP picture and (ii) the first RAP picture type is a predetermined second type, a decoding flag is set, the decoding flag indicating that decoding of a leading picture is to be performed, and
in a case where the decoding flag is set, the first leading picture is decoded.

12. The image decoding method according to claim 1,
wherein, in the controlling, the first RAP picture type is identified using a network abstraction layer (NAL) unit type of a NAL unit corresponding to the first RAP picture, and whether decoding of the first leading picture is to be performed or skipped is controlled according to the identified first RAP picture type.

13. The image decoding method according to claim 1, wherein, in the controlling, when (i) decoding starts from the first RAP picture and (ii) the first RAP picture type is a predetermined type, decoding of the first leading picture is to be performed or skipped is controlled regardless of the first leading picture type, and
when (i) decoding starts from the first RAP picture and (ii) the first RAP picture type is not the predetermined type, whether decoding of the first leading picture is to be performed or skipped is controlled according to the first leading picture type.

14. An image decoding apparatus comprising:
processing circuitry; and
storage accessible from the processing circuitry,
wherein the processing circuitry executes the image decoding method according to claim 1, using the storage.
